(19) United States
(12) Patent Application Publication
(10) Pub. No.: US 2007/0291473 A1
(43) Pub. Date: Dec. 20, 2007

(54) Methods and apparatus relating to improved visual recognition and safety

(76) Inventor: Neil Traynor, Bulleen (AU)

Correspondence Address: DENNISON, SCHULTZ & MACDONALD, 1727 KING STREET, SUITE 105, ALEXANDRIA, VA, 22314, US

(21) Appl. No.: 11/819,180

(22) Filed: Jun. 26, 2007

Related U.S. Application Data
(63) Continuation-in-part of application No. 10/508,693, filed on Sep. 28, 2004.

(30) Foreign Application Priority Data
Mar. 28, 2002 (AU) PS 1465

(51) Int. Cl. F21V 21/08; F21S 4/00; F21V 21/084; F21V 5/00; F21V 21/00

(52) U.S. Cl. 362/106; 362/103; 362/225; 362/235; 362/249

(57) ABSTRACT

A visual recognition and identification apparatus comprising a mounting means adapted for placement on an object wherein said mounting means incorporates one or a plurality of light emitting diodes adapted to provide a visual signal characterised in that said LED's are mounted in, on, or connected to a printed circuit board, wherein said printed circuit board is surface modified to provide a distinct angle of mounting for one or a plurality of LED's to provide a highly defined focused viewing angle for said apparatus, wherein said mounting angle results in the focusing of said LED's at a defined focal point.

This invention relates to the methods and apparatus to visually improve the recognition of individuals, equipment, and define, or identify areas of potential physical danger in poor and very low levels of light.

### BACKGROUND OF THE INVENTION

There exists a need to assist with the visual identification of people and objects in low levels of ambient light. Emergency workers are often required to work in dangerous conditions where there is no available general light (including sunlight) or extremely low levels of illumination. The current safety methods used to identify people; equipment or hazards rely heavily on the use of reflective materials combined within either their safety clothing or reflective signs, barriers or other light reflective materials. All these items require the application of a light source such as a torch or spotlight beam reflecting light off these special surfaces back to the eyes of an observer.

Portable emergency high performance floodlights often provide general lighting. However, the problem is obviously most difficult where there is a low level of visibility such as in smoke, silt, rain and other opaque atmospheres or when non-lineal angles of viewing or a line of sight for an observer does not exist or is obscured. Some incident scenes may not provide a suitable or safe position for the mounting of emergency lights.

Another problem is the glare factor created by a bright intensive light within a dark background. The emergency worker carries a considerable load of equipment and clothing onto sites. Often they will wear a miner's type headlight to allow their hands to be free, unfortunately, this means they are often invisible to people behind them. They are also dependent on guessing the correct place to look if wishing to locate a hazard beyond their existing beam of light. Fellow workers may find it impossible to identify a ‘Buddy’ team mate because of the high source of glare generated by the other's headlamp or torch in the low levels of light often encountered. It is possible for a person to be temporally blinded when looking into a bright light after returning from an area with low levels of visibility. This loss of ‘Night Vision’ may result in placing one's self in additional danger.

A further complication is that it is often difficult for safety workers and others to identify their ‘Chain of Command’ leaders in poor ambient light or Vis versa. It is also desirable to be able to distinguish and differentiate between the different classes of safety workers on an emergency site. Better control and safety on an emergency site are essential needs. Further, it is imperative to easily locate or identify special designated areas, hazards, or a planned line of retreat. Essential tooling or plant may be invisible or difficult to find on a disaster site in the masking atmospheres caused by smoke, chemical haze or other indistinct reasons. Additional obstacles also exist when trying to supervise the security of a site in low light. The simple identification of an authorised essential worker from other workers, victims or even non-suitable observers is vital.

Normal safety lanterns and large torches are cumbersome and unsuitable for many applications. Emergency vehicles are often well equipped with fixed and portable spotlights plus flashing, rotating or strobe style lights and light bars. Unfortunately, they may not be capable of getting their vehicle close to the scene of a disaster, or alternatively providing an essential early warning for other people. Flares and other forward warning signs are not always possible to use, because of high winds, fire risk, chemical or water hazards.

Other parties outside the site of activity, but still within the danger zone often need vital and more informative information. There exists a need for a very flexible, light and programmable message board, easily transported and simple to erect, with low energy requirements.

There is a need to improve the current methods of locating victims in marine emergencies particularly in poor light conditions, or a means to enhance the viability of using infrared and other detection equipment to further assist in such searches.

There is a need to provide a simple visual marker to assist with the evacuation of a burning premise without the complications and cost of a hard-wired emergency lighting system. Most existing domestic smoke detectors only provide an audio warning or a small internal light that has a limited area of illumination. The preferred mounting location for a smoke detector may not position the light in the most suitable position to provide suitable evacuation illumination.

There is a need to provide a more simple, robust, low energy consuming, very long life Traffic Lanterns with an ability to change shape, clearly indicate the time between signal changes and be more readily recognisable by vision impeded and colour blind users. Even the latest LED powered Traffic Lanterns still follow the tradition round lantern shape.

There is a need to provide an emergency worker with a safety vest or article of clothing or other means of personal identification that not only illuminates the worker to provide a visual identification for observers but also additionally incorporates a remotely activated personal tactile, audio, or visual warning signal. The warning signal maybe simply of one type or any combination of the three. The warning signal may be manually activated remotely by a second party or automatically triggered to warn of an approaching danger that may not be visible to the worker. The danger may be physically visible to people outside the area yet invisible to the emergency worker at his current position or it may be detected by various automatic means that then generate a warning signal. This activated personal warning signal may be visual, audio, and tactile or any combination within or on the emergency vest or article of safety wears.

There exists a need for fully recessed (flush) directionally illuminated road stud. Current road studs all project above the current road surface thus being subject to extreme impact damage from traffic. This impact causes wear that may move the stud from its original site or a reduction in its reflective properties. The ability to also signal a lane change, local danger and other temporary road conditions by illuminating the road markers is important.

Whilst the use of LED's as a light source provides many advantages as envisaged by the current invention, the available light from even super bright LED's is limited and in order to address this inherent limitation in the use of such devices, the current invention has specifically addressed the issue of focusing and pinpointing of the available light from LED's by the combined use of physical orientation of LED's to a defined angle, the use of LED's with inbuilt direction or light projection and the use of lensing systems in order to enhance the direction, delivery and intensity of light emitted from the LED light sources utilised in the invention.

Terms Used

An LED is a Light Emitting Diode. A simple Diode is used to control the flow of electricity to only one way in an electrical circuit An LED has a side effect that it produces light when electricity is flowing through it. The principles of LED's are known and depending on the materials selected, shapes and internal components they emit radiation wavelengths that cover the full spectrum of visible light, i.e. all the colours of the rainbow plus the invisible regions at either end namely Ultraviolet and Infrared. Vast varieties of LED's are available to suit many particular applications. These available LED's allow a wide choice of product by the variations in Colour Temperature, beam widths, sizes, light outputs and even mounting differences to help in the selection of the most suitable highly efficient LED for the required purpose. The most suitable colour wavelengths can be further tailored to suit the majority of common conditions encountered by a particular emergency service in their defined regular work. This selection is based on the needs for ‘mesopic vision’ (night vision/very low resolution and black and white only) and photopic vision (day vision).

LED's have many design characteristics over normal incandescent lights that further improve performance when powered by batteries. An LED increases its internal resistance when fed with less power and consequently operates slightly more efficiently. Thus they conserve the remaining energy in batteries weaken with prolonged use. An incandescent lamp just changes colour and fades much quicker.

The LED is also manufactured as an SMD (Surface Mounted Device) allowing even smaller packaging and its highly accurate placement on a PCB (Printed Circuit Board) by ‘Pick and Place’ machinery. This particular feature has allowed the applicant to develop unique solutions to some of the problems detailed below. The PCB is manufactured and worked to provide a stable but flexible base for the mounting of SMD LED's. The PCB can be contrived to provide a designated angle of mounting within a cover so that together with the selected beam width of a particular LED a very precise light distribution is obtained even when the PCB and cover have been made to follow or skin a non flat shape. This is very important in traffic lanterns and safety signals where very precise cut off viewing angles are required.

Statement of the Invention

In one aspect the invention provides a visual recognition and identification apparatus comprising a mounting means adapted for placement on an object wherein said mounting means incorporates one or a plurality of light emitting diodes adapted to provide a visual signal characterised in that said LED's are mounted in, on, or connected to a printed circuit board, wherein said printed circuit board is surface modified to provide a distinct angle of mounting for one or a plurality of LED's to provide a highly defined focused viewing angle for said apparatus, wherein said mounting angle results in the focusing of said LED's at a defined focal point.

The mounting means may be an elongated flexible strip adapted for fixing to a range of substrates.

The mounting means may be a badge or the like adapted to be worn on, over or attached to user clothing. The badge may contain a slim rechargeable lightweight high output battery connected to a flexible, shaped or bendable PCB. The PCB mounts a series of very small LED's designed to illuminate from the back (or rear projection), side or other suitable position a particular insignia or service patch or like identification, which is then visible to an observer in poor light when the Badge is activated. The circuit output is microprocessor controlled to pulse the LED's, or an alternating on/off switching mode or other programs or any combination of these. Appropriate electronic control gear is mounted either on the same flexible PCB or on one or more alternatively connected PCB boards. The totally self contained Illuminated Decal (hereafter referred to as ID) is designed to remain working and visible for at least the shift time an emergency worker would be allowed to be involved at an incident. The ID with integral or detachable battery is designed to be recharged and can be replaced to extend this time if desired. After the incident, the recharged ID is then available to refit to a new or cleaned emergency workers clothing as required.

As a further variation the ID may be incorporated as a flexible moulding sewn into, bonded or otherwise incorporated within the physical making of the emergency worker's garment, vest, jacket, coat, harness and clothing. A further method includes mounting a portable ID strip by Velcro or other temporary means to a designated position on the safety wear. The ID is powered by an attachable rechargeable power pack (battery) incorporated in a pocket or other holding pod within the garment. Alternatively the ID with a battery may be fully self-contained and provide mounting by clip, Velcro or other fastenings to a workers clothing or article of safety wear or equipment.

As an additional embellishment, the LED's may emit in other detectable wavelengths including Ultraviolet rather than a wavelength of directly visible light. The outer cover is treated with fluorescent material and excited by the UV. A further variation uses additional Infrared-producing LED's to supplement or replace several or all of the normal visual light types. These Infrared producing LED's are visible only with the correct equipment and provide an identification code or other requirement for security purposes. Combinations of either two or all three types can be incorporated on the same circuit or on other individual or connected circuits.

In another aspect, the I.D. may be shaped to follow an outline or skin of an inert object such as the door of an emergency vehicle. The ID draws current from the host vehicle's battery or separate power source.

In an alternative aspect, the SMD LED's may be mounted either on one or both sides of a thin flexible PCB configured as a strip within a thin flexible protective cover. The outer cover may be a hard flexible skin of a diffusing medium in which the flexible PCB is suspended. The diffusing medium may be a combination of several layers of fill materials with different reflective and refractive index's combined to provide direction light control. This cover may be transparent or have a diffusing medium or combination of external finishing including silk screening or printed transparency. The outer cover may be shape moulded with either an integrated lens, louvres and/or other mediums for controlling the directional output of the specialised light spread from the utilised LED's. Alternatively the light controlling mediums may be located on separate items but attached externally or incorporated within the I.D. The flexible PCB may be bent, indented, pressed, folded, machined, laminated, treated, pierced, or cut to a particular shape or otherwise worked to suit each particular application. This processing may provide a permanent physical alteration, allow increased flexibility or create an original or planned memory shape if required. The cover may incorporate attachment facilities by Velcro, magnetic strip, double sided tape, permanent mounting brackets, suitable adhesives or cable ties. The end caps or other outer parts may also incorporate a loop or hook to allow suspension.

In another aspect, the ID may be a thin flexible tube containing a PCB, appropriate SMD LED's plus a microprocessor controlling circuitry, end caps and powered by rechargeable batteries. With the correct wiring, they can be hard wired to extra low voltage or extra low energy circuits. The PCB may be flat or worked to allow very controlled beam angles when the tube and the attached components are bent or curved to suit a desired mounting configuration. The working of the PCB can be to provide a defined profile beam cut off angle or allow greater bending flexibility. These long thin units are given the name LIGHTFINGERS. LIGHTFINGERS may be of various lengths and contain different numbers and types of LED's. Special end caps and joiner inserts plus additional electronics on the PCB(s) allow joining of multiple runs of LIGHTFINGERS. These runs can be in various planes and curved to follow a profile as required.

In another embodiment, the invention may incorporate a particular number and arrangement of SMD LED's to serve as a message board. All control of the electronics is by integral microprocessors The message board may be pre-programmed with a simple number of messages, switched either from a remote location, or to deliver a live changeable message using a computer with suitable programming. The message LIGHTFINGER is designed to be powered by an extra low voltage external power source.

In an added embodiment of the invention, the LIGHTFINGER batteries maybe recharged by Solar or other renewable energy sources.

In a further aspect a simple LIGHTFINGER or ID maybe switched by an external audio signal either within a normal human hearing range such as the generated noise from an activated domestic type smoke detector, or outside human hearing ranges to avoid detection when required. A further switching could be by a remote infrared transmitter to an incorporated infrared receiver or other wireless transmissions and reception.

An alternative use allows the LIGHTFINGER or ID switching by an automatic detector incorporated within the basic unit or with a remote detector located in an appropriate separate location. The LED's which are normally of the high output visual types may be substituted with infrared emitting or other detectable wave length LED's when appropriate to allow use as stealth mode indicators for security use.

In another embellishment, The LIGHTFINGER or ID may also be located at, affixed or placed in a suitable location to visually mark a hazard or tool. Different visual description provided by the choice of suitable colours, widths of beams, control including a pulsing or static output and the general configuration and number of the LEDS on the PCB or overall shape of the LIGHTFINGER or ID.

A further enhancement of LIGHTFINGER maybe encased in a specialised outer water and pressure proof cover to allow its use under water or for added protection in varying dangerous conditions of use with hazardous materials or extra heavy duty applications.

A further function uses a specialised LIGHTFINGER for marine rescue. The LED's may be visual, ultraviolet, infrared or other detectable types or any combination. The PCB and cover return to an original memory shape to float when released from a storage shell.

Another adaptation bends a special LIGHTFINGER either around a power pole or down the pole or as a combination of both and yet retains a defined beam angle and clear controlled visual cut offs. This flexibility with controlled cut off angles allows new versatile designs for traffic signals with increased mounting adaptability and extremely long maintenance periods. The traditional round lantern lens can be replaced with more versatile designs that do not required heavy lantern bodies, extensive louvers and hoods to provide cut off angles or combat sun phantom problems.

The ‘round the pole’ display may have distinctive facets to provide an observer at the designated viewing angle with a single colour traditional round traffic lantern type display. Other viewers at different viewing positions see another coloured traditional type round face. These round lantern typefaces provide different messages by way of colour such as Green (to go) in one direct whilst a facing Red lantern face stops traffic in another direction. Thus ‘one round the pole’ display can replace multiple lanterns. A single display band may be used to replace a traditional 3-lantern aspect (Red, Amber, Green) The LED's are of the RGB type that allow changeable colour displays. Alternatively single bands may be combined to provide a traditional 3-lantern type aspect. The top band Red, a middle band Amber and the bottom band Green, further bands or display inserts may be illustrate arrows, ped crossings messages or even emergency vehicle warnings. In addition instead of the tradition round face other very clear distinctive recognisable shapes such as a square, diamond, triangle may replace or supplement the standard round display. This very visual display will greatly assist people suffering from limited vision or colour blindness to use Traffic Lantern controlled intersections. Furthermore the flexible display medium of LED's can provide a time down or moving visual indication of changing times between cycles. This time may be illustrated by a progressive colour change between the traditional distinctive signal colours. The Red display slowly changes to amber to indicate the time left, the green may slowly appear to creep off the face and be replaced by an amber tinged green to emphasise the approaching Amber warning phase or other programmable alternatives. A further embellishment would be an additional boarder, shape or other visual indication within the lantern combination switched remotely by an emergency vehicle warning of its imminent arrival in the intersection. Further, audio warnings could be included on part of the new PCB.

A further need exists for a completely recessed intelligent road marker to replace the raised traffic control studs currently used. The markers top is flush with the existing road surface and allows adaptable traffic lane control or to provide an illuminated hazard warning. The very directional control of lighting required is provided by the selected LEDs, the shaped PCB and the fill mediums used.

In another aspect the invention provides a visual recognition and identification apparatus comprising a mounting means adapted for placement in a physical environment wherein said mounting means incorporates one or a plurality of light emitting diodes adapted to provide a visual signal characterised in that said LED's are mounted in a printed circuit board.

Accordingly, in further aspects the invention provides a badge, clothing accessory, clothing patch, animal collar, emergency warning device, fire alarm system, message board, road or rail warning system and a point of sale message board all characterised in incorporating the apparatus as previously described.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### DETAILED DESCRIPTION OF THE INVENTION

The invention will now be discussed in detail by reference to the following Figures and Legend:

### LEGEND

### Summary of Numbers Used to Illustrate Drawings

Number Description

1. Surface Mounted (SMD) high performance LED's
2. Flexible PCB board mounting selected electronic control components.
   Maybe pressed, cut, folded, treated, laminated or any combination to improve flexibility.
3. Protective flexible membrane with outer skin, clear, coloured, or with internal coatings.
   Maybe finished to diffuse, direct, colour, fluoresce or otherwise alter the LED's light
4. Possible mounting methods: Magnetic tape, Velcro, double sided tape, Adhesive backing, clip or hook or other means.
5. Possible base profile of cover (3) to allow invisible mounting
6. Basic lineal component of LIGHTFINGER, consists of
   (1) LED's
   (2) PCB with electric components to suit application
   (3) Protective flexible membrane with tough skin.
7. End caps containing rechargeable battery or connections for hard wiring.
8. Live end with quick fit connectors for hard wiring.
9. Dead end caps, may be fitted with mounting ring or holding hook.
10. Flexible joiner with wiring connecting 2 or more LIGHTFINGERS together.
11. Live end with battery and remote controlled switching
12. Live end with power pack and remote switching facility.
13. Battery Power Pack
14. CLIP ON ID Illuminated identification Badge. (ID=Illuminated Decal)
15. Cover of an ID may be moulded, silk-screened, or with a transfer or other representation.
16. Rank identification: bands, colours, or badge etc
17. Another style of ID: SLIP ON type
18. Flexible PCB board with LED's, electronic components in a flexible cover.
19. Shirt, Coat, Jacket, uniform or other outer garments or hazard protective clothing.
20. Safety headwear, cap or hat
21. Representation of directionally controlled light output.
22. Sewn in, bonded or otherwise mounted I.D.
23. Lappets or shoulder flaps on shirt, jacket, coat or hazard protection garment.
24. A complete LIGHTFINGER composed of
   (1) LED's,
   (2) Flexible PCB, with electronic components
   (3) Flexible cover
   (7) Live end with rechargeable battery pack
   and (9) dead-end cover.
25. A waterproof pressurised outer cover for use by sea salvage or other specialised needs.
26. Doorjamb
27. Hazards: Hole, Chemical spills, debris, dangers or Depot: Extra tools etc.
28. Water Pipe
29. Tripod
30. Safety Cones
31. Safety Chain between Cones
32. Roadside Picket or Pole
33. Tree Branch
34. Motor Vehicle at Accident Scene
35. LIGHTFINGER hard wired into outer door rubbing strip or vehicle profile.
36. Car Door
37. Emergency Vehicle
38. LIGHTFINGER mounted behind and attached to the profile of a stone deflector
39. ID as a lighted panel shown on door of emergency vehicle (hard wired)
40. ID incorporated as a surround or fill in around number plate
41. LIGHTFINGER mounted outside to the profile of the curved rear window
42. LIGHTFINGER mounted inside to the profile of the curved windscreen
43. LIGHTFINGER configured as a flexible message board behind windscreen.
44. I.D. panel on a car door, electrical connection from easy plug under mirror.
45. Fold out LIGHTFINGER flexible message board
46. Fully viewable LIGHTFINGER uniformly lighted message shown as a directional arrow on a curved and sloping cone shape
47. Police Bike with extended LIGHTFINGER message board
48. Water Rescue tube containing
   (49) Very thin special memorised and shaped LIGHTFINGER
   (7) Battery Pack to suit application requirements
   Case may also contain marking dies, streamers or foil strips
49. Very thin special shape memorised LIGHTFINGER with either
   (1) SMD VISUAL LED's or
   (50) SMD INFRARED LED's or
   (50) & (1) LED's in combination
50. SMD INFRARED LED's
   Specified special frequency emitting LEDs
51. Sea Surface
52. Smoke detector with Audio Alarm signal
53. Audio Signal Representation
54. Power Point
55. Small LIGHTFINGER, double sided tape mount.
56. Connecting Lead
57. Flexible LIGHTFINGER message board contoured to the profile (reversed image shown)
58. Remote switcher for (57) LIGHTFINGER. Infrared, RF, audio or other methods.
59. Stealth use. Camouflaged rock shape may use normal visible or specialised LEDs.
60. Recharging Connections
61. Finishes to LIGHTFINGER: Reflective material
62. Finishes to LIGHTFINGER: lens moulding
63. Finishes to LIGHTFINGER: Silk screening, embossed, moulded, transfer etc
64. Finishes to LIGHTFINGER: diffuser finish to material
65. LED's arranged behind ID's skin to show number, letter or other recognition.
66. Special LIGHTFINGER with angled lenses, hard wired, flush mounted in road.
67. Pedestrian Crossing.
68. Road Surface
69. Special LIGHTFINGER wrapped around a powered pole. Configured as a Pedestrian Crossing signal. The display can imitate a normal round lantern face or project specialised symbols and distinctive shapes.
70. Power Pole
71. Representation of standing Pedestrian in RED LED's and/or red screening STOP.
72. Representation of GREEN LED's to represent a round signal lamp. GO
73. Representation of RED LED's to represent a round signal lamp. STOP or hand signal.
74. Representation of LED's to represent a round AMBER signal lamp.
   CAUTION
75. Representation of WALKING Pedestrian in LED's. AMBER light for caution
76. Representation of WALKING Pedestrian in GREEN LED's and/or green GO
77. External louvre may be moulded in cover or as a separate attachment.
78. Internal louvre may be moulded in cover or separate.
79. Portable point of sale fixture comprising
   LIGHTFINGER message board
   Base with rechargeable battery or hard wired
80. Optional Solar Cell
81. Series of LIGHTFINGER together
82. Conventional traffic signal lanterns. Round face incandescent 3 colour lens
83. Pole Viewed from Rear
84. Moulding on cover to provide pin hole focusing
85. Moulding to provide a focusing shaft for the light from the LED.
86. Parallel faces of the mounted SMD LED's
87. Parallel cut off angles for the visible light from the SMD LED's
88. LIGHTFINGER mounted vertically to represent a conventional traffic Lantern with the three traditional round lantern faces.
   Mounting direct to a power pole by mechanical clamp or adhesive.
89. The same configuration as 88 but with additional warning lights
90. Light segments acting as warning lights activated by an approaching emergency vehicle or other remotely operated switching signal
91. The same configuration as 88 but with differently shaped signal lights
   To assist with additional identification and recognition
92. The same configuration as 88 but with continuous colour changes.
93. The red ‘STOP’ signal represented as a diamond shape
94. The yellow ‘CAUTION’ signal represented as a spiked circle
95. The green ‘GO’ signal represented as a soft rectangle.
96. Light segment of SMD LED's representing the red ‘STOP’ signal
97. Light segment of SMD LED's representing yellow ‘CAUTION’ signal
98. Light segment of SMD LED's representing green ‘GO’ signal
99. Spikes light first to give a warning of a light change. Could also be part of an approaching Emergency vehicle warning.
100. Extra segment of light bands that could be used to indicate time elapsed or configured to allow warning signal for approaching Emergency vehicle.
101. ID moulded to fit dog collar or as a badge
102. Emergency Services Rescue Dog
103. RAIL CROSSING
104. Solar Panel
105. Storage for Battery, Electronics & Switching gear
106. Built in blackboard (or target board) to improve visual identification of a signal
107. Another form of personal I.D. removable shoulder flash
108. The enclosing sides are coloured to assist in recognition
109. The bottom of the illuminated badge projects extra light to improve identification.
110. Clip in flexible message panel. May indicate a different part of a message or a symbol or be part of the message displayed on the other panels
111. Panel mounted to face an alternative direction to the main message on the base unit.
112. Clip together LIGHTFINGER flexible message board (Panels).
113. Smoke alarm companion and emergency stand by light piggybacked over a power point.
114. Smoke alarm companion recessed into wall cavity
115. Spring clips to hold unit in place and allow easy removal for battery changing
116. Cover plate may use a simple LED display or a stylised symbol to indicate the safety pathway.
117. Flexible message type LIGHTFINGER wrapped around a hollow pole to create a 360-degree stand alone signal display
   Conventional type round single faces with very defined cut-off angles of viewing
   A full moving message including symbols
   Or a static or active or moving colour data display
118. Hollow pipe mounted vertically in the ground
119. Gear tray suspended within a hollow pipe carrying all control gear including rechargeable batteries, and remote switching facilities. The gear tray counterbalances the vertical mast and attachments
120. Control gear with all the components to operate the wrap around light display. Additional ancillary gear such as Pulse radar etc.
121 Vandal and weatherproofed cap to seal all components within the pipe. The exception is an optional mast to carry attachments.
122 Mast to carry optional radio antennae or solar panel.
123 Solar panel. Unit may also be mains powered or supplied with energy from a remote wind or water generator
124 Radio antennae for remote control.
125 Optional external switch
126 Non removable triage band
127 Illuminated Triage Tag
128 Front of a safety vest with lightfingers
129 LIGHTFINGER configured to provide a short focal length hands-free torch for the safety vest wearer. Focal length may be adjustable.
130 Activated tactile warning
131 Activated audio warning
132 Safety vest back showing lightfinger inserts illuminating wearer

FIG. 1a A simple flexible very small strip PCB (2) shown with surface mounted LEDs (1). (SMD LED's)

FIG. 1b A flexible PCB (2) shown flat with SMD LED's (1) suspended and encased within a flexible membrane (3). I.e. a LIGHTFINGER. The light output is directional and controlled y the selection of the LEDs, the engineered shape of the PCB when placed in situ and may be further enhanced by the use of several fill materials with different and complementary reflective and refractive indexes. Further control may be incorporated by a outer skin moulding.

FIG. 1c A possible profile to allow flush or hidden mountings for some uses of LIGHTFINGERS such as when it is semi permanently mounted as a simple fire alarm emergency light way.

FIG. 1d The basic components used for a standard LIGHTFINGER (6)

Drawing 2

FIG. 2a The PCB (2) may be pre-folded or pressed to shape. Always the mounting pads for the SMD LED (1) are in the stress free sections of the PCB.

FIG. 2b The PCB (2) may be folded, pressed, slotted, cut or otherwise mechanically worked to provide a defined mounting design.

FIG. 2c The PCB (2) may be modified by a combination of several methods as discussed above or any other suitable means including chemical treatment, laminations or variations in thickness etc. To tightly control or modify the light beam angles from the selected LEDs (1) their base or connection pads on the PCB may be worked to form a specified angle of mounting when the ID or LIGHTFINGER is bent to a predetermined profile. Further light control may be provided by the use of several flexible fill materials (3), to project the light in a predetermined direction or provide an additional reflective surface, or in combination. Critical application such as Traffic Signals require rigid cut off angles. This angle may place the emission faces of a designated number of SMD LEDs (1) parrel (86) to each other or at a specified angle to each other in all planes when the LIGHTFINGER is required to follow a curved shape or fluid profile.

FIG. 2d A basic PCB (2) with SMD LEDs (1) shown from several angles

FIG. 2e The LEDs (1) mounted on a double-sided PCB (2).

FIG. 2g The LEDs (1) may be angled to suit controlled light beam emissions. The SMD LEDs (1) follow the profile of the shape taken by the PCB; this is different to 2c where the PCB (2) is ridged to keep the faces (86) of the SMD LEDs in the same direction. Faces are parallel and the light output (21) of the selected LEDs are highly controlled.

Drawing 3

FIG. 3a An ID (15) as a completely self-contained weatherproof unit containing battery, PCB with LED's and control gear with an on/off switch. Velcro, loop, hook or other mechanical means mounts the badge. (4)

FIG. 3b An ID (14) as a self contained illuminated Clip-On shoulder or pocket patch with rechargeable battery.

FIG. 3c Slip-On ID (17) used on the button down shoulder flaps or lappets (23) of an Emergency workers clothing (19).

FIG. 3d Very flexible thin LIGHTFINGER moulded or affixed within clothing joints (18), the rechargeable battery pack (13) is stored in a pocket or pouch. The LED's can be of the UV-A emitting type that excite florescent or phosphor powders inside the outer cover to produce a continuous soft glowing piping. Alternatively the emitted light may be white or a selected colour or any combinations.

Drawing 4

FIG. 4a Self contained ID (15) with rechargeable battery attached as a shoulder patch. Attachment to clothing (19) may be by Velcro, Loop, or special pouch within the garment. Alternatively attached by mechanical means such as a hook, pin or loop.

FIG. 4b Self contained ID (15) with rechargeable battery worn as headgear (20). The curved PCB may be engineered to provide better identification of the wearer and/or a measure of focused forward light.

FIG. 4c Self contained ID (15) with rechargeable battery attached as a pocket flap.

FIG. 4d A self contained LIGHTFINGER combined within a dog collar (101) on a rescue dog (102). Alternatively, an ID may be attached as a pendent from the collar. Certain segments of the collar are engineered to project light forward/down or other specified lighting control.

Drawing 5

FIG. 5a The back of a coat (19) with an ID (22) panel. The power source, a small rechargeable battery is held in a special pocket in the coat.

FIG. 5b Slip-On ID (17) for shoulder flap use on shirts, jackets, coats or other suitable emergency apparel (19). The unit is self-contained with a rechargeable battery. Different configurations could be used on separate shoulders. E.g. left shoulder Police and the right shoulder a different colour or symbol of their Rank to further assist identification.

FIG. 5c A very small LIGHTFINGER (18) with special outer soft pliable profile allowing sewing or bonding into clothing (19) or even a Safety Harness. The battery is held within a separate compartment or pouch. To obtain a soft glow the SMD LED's may be of the ultraviolet type and the cover treated to fluoresce. The curved PCB may be engineered to provide a better identification of the wearer and/or a measure of focused forward light.

FIG. 5d A removable shoulder flash/badge (107) incorporating an I.D. The patch is secured by Velcro or other fixing at the sides and enclose it around the arm of the wearer. The top party is secured by allowing a garments' shoulder flap (23) to pass through the slot. Where the wearers garment (19) does not incorporate a hold down shoulder flap Velcro or other fixing methods are employed. Engineering of the PCB and filler selection allows directional lighting control.

Drawing 6

FIG. 6a The outer case or cover/filler (3) of the LIGHTFINGER may be finished in a variety of ways. Reflective materials (61), lens (62), etc (63, 64) for directional control or silk-screened, printed (63) or with selective inner or outer transparencies or partial transparency or several diffusing finishes. Further light control may be provided by the use of several flexible fill materials (3) to project the light in a predetermined direction or provide an additional reflective surface, or in combination.

FIG. 6b Two bendable LIGHTFINGER strips joined and wired by a flexible joint (10) allowing mounting in all planes.

FIG. 6c Fully self contained LIGHTFINGER (24) encased within a pressure protected and heavy duty outer (25) for use in undersea salvage use or very hazardous chemical spills that would damage a normal fitting.

FIG. 6d A view of a curved LIGHTFINGER in one plane

FIG. 6e A view of a modified PCB (2) worked to provide a firm base for the mounting of a SMD LEDs (1).

FIG. 6f Cross section of a curved PCB in a LIGHTFINGER allowing a broader light spread. The PCB (2) is suspended within the cover (3). Engineering of the PCB and filler selection provides focused and directional lighting control when required.

Drawing 7

Portable rechargeable LIGHTFINGER (24) for use in hazard conditions

FIG. 7a LIGHTFINGER (24) attached to a door surround (26) as a safety marker/way out. Held by self adhesive tape.

FIG. 7b LIGHTFINGERs (24) placed in various strategic positions to clearly mark hazard areas or define strategic store areas eg. special tool dumps.

FIG. 7c LIGHTFINGER (24) hung as a warning of dangerous overhead projections (28) that may be difficult to see normally.

FIG. 7d A LIGHTFINGER (24) hung from a simple tripod (29). Provides very stable mounting when used in heavy winds or other poor conditions such as water over the road.

Drawing 8

Various applications of portable and rechargeable LIGHTFINGERs (24) at an accident site. Apart from just being placed on the ground similar to a simple road flare the LIGHTFINGER may be hung, supported by clips, self-adhesive tape magnetic stripping or attached to a traditional emergency road cone (30), or the crashed vehicle (34).

Drawing 9

FIG. 9a A LIGHTFINGER (35) inserted as part of a vehicles rubbing strip. The light is selectively directed to illuminate the adjacent car panel to assist in clearer identification.

FIG. 9b Profile illumination of an Emergency Vehicle (37) by a series of flexible LIGHTFINGERs (35) hard wired to the vehicles battery. Note a further refinement is to use SMD LEDs emitting Ultraviolet preferably in the safe UV-A wavelengths. The outer cover is coated internally with florescent or phosphor materials to react and transmit visible light. I.e. glow in the dark. The vehicle's profile is clearly defined.

Drawing 10

FIG. 10a A waterproofed hard wired LIGHTFINGER (38) or alternatively a flexible message board (57) mounted behind a contoured deflector. The curved displayed message is focused to present a flat image and avoid glare to on-coming traffic.

FIG. 10b A large ID panel (39) and LIGHTFINGER (35) mounted on a vehicle's door. The light output is focused to illuminate the sign and curved door panel and avoid glare.

FIG. 10c A specially moulded ID or LIGHTFINGER (40) to fill the number plate surround. In addition an externally mounted weatherproofed LIGHTFINGER (41) contoured to follow the window but with focused light output.

FIG. 10d A LIGHTFINGER (42) mounted behind and following the curved windscreen profile. The engineered PCB, selected LEDs, and fillers combine to present a flat visible focused light output.

Drawing 11

FIGS. 11a-c A LIGHTFINGER message board (43) mounted on the vehicle's sun visor (s). The flexible message board follows the internal contour of the sun visor. The rear vision mirror splits the LIGHTFINGER message screen. The sun visor (s) fold down to provide a better viewing angle when operating.

FIG. 11d A message can continue across both segments as one continuous message or provide two separate messages pads.

Drawing 12

FIG. 12a A large ID (44) mounted on a vehicle door. The engineered PCB, selected LEDs, and fillers combine to present a weatherproof, even, flat, visible, diffused light output illuminating the sign and/or sections of the door. The illuminated ID panel may be semi permanently mounted and draws power from the vehicle circuits.

FIG. 12b A LIGHTFINGER message board (45) that normally carries the message face against the door skin for protection but is folded out or reversed when required to show a message. A message is selected from a collection of pre-programmed messages accessed by a numerical keyboard (in vehicle) or by connection to live programming by laptop or an RF signal from a central command. The circuitry is designed to suit the required source.

FIG. 12c A foldout LIGHTFINGER flexible message board secured around a circular fixture for storage and support when opened viewed from above. Depending on the engineered PCB, selected LEDs, and fillers this presents as a flat visible focused light output when unfolded.

FIG. 12d The LIGHTFINGER flexible message board (46) extended and stabilised on the rear of a stationery police bike.

FIG. 12e Another style of LIGHTFINGER message board (45). It may be folded in a variety of ways or detached for ease of carrying and storage. Folded out or clipped together panels of a segmented LIGHTFINGER message board. The message flows across all panels or alternatively provide separate messages on the single segments.

Drawing 13

FIG. 13a Fold out LIGHTFINGER message board (45) using an external power supply (56). Designed as a simple storage case when folded for ease of carrying and protection. May be mounted on a tripod or by other methods to improve visibility at site. The messages can be pre-programmed and simply displayed by number selection, changed with a lap-top live program on site, or with suitable equipment may be controlled remotely. Panels (112) may be folded or unclipped for storage. Panels may be attached at the top or bottom of the central panel as well as the sides. Panels may also be configured to shine in an alternative direct to the primary display.

Drawing 14

Special version of a LIGHTFINGER (48) designed for Marine Rescue.

FIGS. 14a-f Shows a closed capsule containing a spiral stored LIGHTFINGER (50) treated to return to its original flat state and float on the water surface (51) when released. An alternative allows the LIGHTFINGER (LED's mounted double sided) (49) to stand up as a visible beacon. The release also turns on the LED's. An internal battery powers the LIGHTFINGER. The packaging may also contain streamers, soluble dies, foils or other items to further aid visual or other means of detection. The LED's may be the normal visible light producing type (1) or infrared or selected (50) to emit in another specialised wave band or a mixture depending on requirements. A specialised Search and Rescue detection unit could specify an actual emission wavelength for greater identification.

Drawing 15

FIG. 15a A special version of a LIGHTFINGER (55) for use with normal domestic type smoke detectors (52). Very fine, clear covered LIGHTFINGER (55) with battery and audio switch tuned to the audio output of an existing smoke alarm. The audio signal (53) activates the LIGHTFINGER strip (55) without any wired connections between the detector (52) and the LIGHTFINGER (55). The encased LIGHTFINGER strip may be engineered to focus a proportion of light on the adjacent wall or the floor to further assist the evacuees. Alternatively a RF switch in the LIGHTFINGER may be triggered by a wireless RF generator built in or attached to a smoke alarm when the alarm is activated by smoke. Other wireless switching systems such as infrared may be used. A further enhancement may be the provision of a solar cell (80) with the casing and the applicable recharging circuitry to increase the life of the battery. Other models may use a laser or other illuminating lights to indicate a safe pathway when remotely activated by a smoke alarm. Simply D.I.Y. installation.

FIG. 15b A similar special LIGHTFINGER (55) with flexible wiring from a power pack (12) (including a rechargeable battery) permanently plugged into a GPO. This unit is activated by the audio output of the smoke alarm (53) during a fire, or by the loss of power in the host circuit. It remains on stand-by at all times. The unit triggers ON during a power failure to act as an emergency light way marker. Simple D.I.Y. installation. The LIGHTFINGER is very thin, clear covered and mounted by non-visible self adhesive tape to allow unobtrusive placement along architraves, window frames or door surrounds etc. The encased LIGHTFINGER strip may be engineered to focus a proportion of light on the adjacent wall or the floor to further assist the evacuees.

FIG. 15c A special LIGHTFINGER designed to piggy back a normal GPO power point (54). The unit allows normal use as a power point with pass through connections maintaining the rechargeable battery. This unit is activated by a remote output of the smoke alarm (53) during a fire, or by the loss of power in the host circuit. It remains on stand by at all times. The unit triggers ON during a power failure to act as an emergency light and/or pathway marker (113). In a variation the light output may be directional. Simple D.I.Y. installation

FIG. 15d A similar special LIGHTFINGER (114) but recessed into a hollow wall cavity. All wiring including a simple battery (13) are behind a small front plate. The unit is held in place by spring clips (115) or other means to allow simple removal for battery replacement. This unit operates in a similar method and is activated by the external signal from the smoke alarm (53) during a fire. The front plate (116) lights to provide an emergency light way marker. Simple D.I.Y. installation

Drawing 16

FIG. 16a A special small version of a waterproof LIGHTFINGER (59) for outdoor use as a pathway guide or for military force use. The LEDs may be visual light emitting (1) or other wavelength types (50). The self-contained units may be used singularly or in groups and activated by remote control (58). The cover may be camouflaged to hide in a garden or other areas. A recharging solar cell may form part of the unit.

FIG. 16b An ID badge design (15) showing how the LED's may be used to either just backlight the badge or to further provide a hidden marker (65) (shown as a P) for additional identification or extra security. The LED's defining the symbol (in this case the P) are infrared and only visible to people with special infrared viewing equipment such as on site security. The internal PCB is processed to compensate for curvature allowing focused light output.

Drawing 17

FIGS. 17a-b Specialised road use of a flat faced fully recessed LIGHTFINGER (66) directionally straight to the line of sight of an approaching vehicle driver. Note the distinct angle of light emission (21). This is achieved by selective engineering of the PCB (2), LEDs, fillers and treated flat cover (3). Light emission could be sideways or other defined directions. Simple installation using road marker adhesive and regular road cutting procedures ensure minimal disturbance to the road surface. Wiring may be normal hard wire connections or by non contact induction loop buried within the road.

FIG. 17c A series of LIGHTFINGERs defining a rail crossing (103) powered by storage batteries (105) charged by solar power (104). The control gear also includes a switching receiver or remote track mounted hard-wired switch. The LED display (66) may be static or pulsing. The approaching train's transponder switches the LIGHTFINGERs on at a safe distance before the crossing. Other source of power may be used. The LIGHTFINGERs are arranged in the road to show a Crossing (X) but other symbols can be mounted on a suitable designated vertical service, including wrapping around the warning pole(s). The distinct angles of light emission (21) required are achieved by selective engineering of the PCB (2), LEDs, and fillers (3).

Drawing 18

FIG. 18 Shows a specialised use for a LIGHTFINGER as a replacement for the conventional Pedestrian Lantern (82). Three rows of LIGHTFINGERs (69) are fitted around a supporting pole (70) or other suitable vertical structure. Each LIGHTFINGER strip has been carefully processed to provide four very distinct images (71,73,71,73 or 75,74 75,74, or 76,72,76,72) with strongly defined cut off angles (21), so that only one image is visible at a defined viewing angle to the LIGHTFINGERS on the pole. The images are also programmed to function similar to a conventional lantern so that only one image (71,72,73,74,75 or 76) is illuminated on each side at one time. These images may represent a conventional round signal as visible on current traffic lanterns or a universal symbol. The use of symbols is of particular relevant for colour-blind pedestrians using controlled crossings.

It is possible to use just one LIGHTFINGER and change the colours and symbols by rotation (circuit only not physical movement) to provide crossing discipline. Shown flat on the drawing.

The controlled light output (21) from the wrap-around LIGHTFINGER (69) duplicates the controlled light output of the conventional traffic lanterns (82).

The LIGHTFINGER can be manufactured to suit a particular site needs with one image to more than four if required. In all cases the correct cut off viewing angles are engineered to reproduce the light control (21) to suit the relevant traffic control Standards when correctly mounted.

Drawing 19

FIG. 19a The directional light output (21) characteristic of SMD LED's (1) is further enhanced by the bending of the PCB (2) to a defined angle (when mounted in a final fixed application). Additional fine focusing control is provided by the selected fillers within the flexible membrane (3) to suit the required function.

FIG. 19b The ultimate light output (21) may further be modified or redirected by a lens (62) moulded, machined or created by the interaction of selected flexible fillers (3) with different reflective and refractive indexes. This light output control may be required in several defined planes to the viewer.

FIG. 19c The outer skin of the flexible membrane (3) may be further modified by mouldings, silk screening, or inserting diffusing or reflective materials, or the interaction provided by fillers with different refraction and reflective indexes, or other wise worked. Examples A built-in reflective surface (61), a Lens (62) with defined angles of focus to a viewer, a very bright pin hole (84) focused output, a moulded light shaft to reshape the projected light from a selected LED (1) and internal or external louvers and/or baffles offering final light control in several planes to a viewer.

Drawing 20

FIG. 20a Possible Point of Sale unit. Rechargeable base (79) and LIGHTFINGER message board (46). The light output from what is a viewed surface curving away in several planes from the viewer has been engineered to project a uniform light display. Normally the light on the sides and top sloping away from the viewer would be dull or not even visible. To present a uniformly lighted arrow direct to the viewer would require a flat viewing surface.

FIG. 20b A simple LIGHTFINGER spirally wrapped around a pole but engineered to present full and complete vertical images or text at certain defined viewing angles.

FIG. 20c Three LIGHTFINGER strips (81) spiraled around a pole (70) at an angle. The message or image may be combined over the three strips and engineered to present a uniformly lighted display at certain defined angles to a viewer. By programmed control of the strips the message may present as a single large vertical text over the three LIGHTFINGER strips or individual lines of smaller text per strip moving in any direction. However all being uniformly visible to a viewer at the designated focal position. Multiple message strips may be enlarged by the addition of extra strips and suitable programming.

Drawing 21

A series of selected uses for LIGHTFINGERs where focused light may be critical.

FIG. 21a-b A simple LIGHTFINGER message strip (117) wrapped around a vertical capped hollow pipe (118 & 121). The illuminated display (117) is engineered to provide very defined viewing angles. The internal cavity of the pipe encapsulates all control gear, batteries and other components (119, 120) to allow operation as a stand along Traffic Signal. May be used singly or in groups and powered by mains or other means (123). Control is by a conventional PED switch or keyed switch (125), remote hardwired switch, wireless signal or other traffic detection hardware. An optional mast (122) may support a solar panel (123).

FIG. 21c An illuminated Triage marker (126) or tag (127). Designed to be attached to a patient at an incident site with the activated colour or combination of colours and selected pulsing rates displaying the initial diagnoses to an extracting emergency worker. The LIGHTFINGER may be configured to light around the patient as well as illuminate the Triage indicator. An optional voice chip or other readable marker may be included. For military use the LEDs used may be of a non-visible type (50).

FIG. 21d-g An emergency illuminated safety vest (128 & 132) with embedded focused by flexible LIGHTFINGER sections. The front LIGHTFINGER panel (128) is configured to provide a short focal length torch (129) at arms length. The other LIGHTFINGER inserts are constructed to be visible from certain viewing angles. Parts of the vest may also be activated remotely by automatic detection equipment of manual switch. The received warnings can trigger a tactile (130), audio (131) and/or visual (6) indicators on the vest. The rear (132) of the vest has the LIGHTFINGER inserts arrayed to ensure visibility at wide viewing angles plus assist a viewer to recognise the wearer in hazardous conditions by lighting adjacent parts of the vest. Similar safety features and warnings may be incorporated in an illuminated safety harness worn over existing safety clothing.

Drawing 22

A series of drawings showing how a LIGHTFINGER is configured to provide a defined light output (21). Note the additional effect/control on the light output by the fillers (3) is disregarded for these drawings.

FIG. 22a A flat PCB (2) with selected LED's (1) showing the cut of angle of generated light (21).

FIG. 22b A reproduction of the same angle of cut off light (21) from a worked PCB (2) mounted around a curved surface. The mounting pads are manufactured to provide a parallel face (86) on all selected LEDs when curved and supported around a pole (70). Alternatively the pads can be worked to position the selected LEDS (1) to provide a designed focal length.

FIG. 22c Examples of the light output (87) shown in 22b if the PCB (2) was not worked to compensate for the curved mounting. The cut-off angle is much wider and may be invisible to a viewer from some angles. Totally unsuitable for use as a wrap around Traffic Lantern. Altering the PCB (2) from a flat to concave or convex changes to cut-off light emissions (87) from a selected LED (1).

FIG. 22d LEDs (1) are available in a very large range of defined angles of light emission (21), colours, levels of illumination, base mounts and types. The projected light is normally measured from the vertical at right angles.

A LIGHTFINGER uses a combination of bending or working of the PCB (2) to direct or focus the light when mounted in situ. Additional control uses the reflective and refractive indexes of the flexible fillers (3) and outer protective skin finishes.

Drawing 23

FIG. 23a An example of a vertically mounted LIGHTFINGER (88) as a direct substitution for a conventional 3 gang Traffic Signal Lantern (82). The LIGHTFINGER's body (88) curves laterally around the circular profile of the pole (70) whilst the light outputs (72, 73, 74) are contrived to reproduce the mandatory cut off angles and present a light pattern to a viewer as are normally provided by conventional round face Traffic Lanterns (82) hung off a pole. Much of the supplementary hardware carried by conventional Traffic Lanterns (82) is not required.

FIG. 23b The same configuration as in FIG. 23a but with an additional pair of light strips (90) that can be activated by an approaching Emergency vehicle. The pole hugging LIGHTFINGER (89) may be worked to provide a variety of messages.

Drawing 24

FIG. 24a Another example of a vertically mounted LIGHTFINGER (91) as a Traffic Signal Lantern (82) substitute. The LIGHTFINGER's body (88) curves laterally around the circular profile of the pole (70) yet the light output is configured to show as three distinct shapes (93, 94, 95) to improve visual identification (particularly important with colour blindness) rather than the conventional round lens. Desired cut-off angles are achieved by the PCB modifications providing the correct mountings for the selected LEDs and fillers used. Further the LIGHTFINGER can present its own blackboard (106). The central yellow/amber CAUTION has spikes (99) that could shrink as a time change countdown indicator, or otherwise pulse or change to indicate an approaching Emergency Vehicle requiring right of way.

FIG. 24b A further design for a LIGHTFINGER (92) based Traffic Signal Lantern. The shape permits light creepage segments (100) to indicate an approaching signal status change. The flexibility of a single LIGHTFINGER even allows for a single unit with programmable colours, shapes and messages to substitute for three individual lanterns.

Drawing 25

FIG. 25 shows a side view of a mounting configuration for an apparatus of the invention where the PCT mounting board (2) is provided in a step configuration such that the mounted LED's (1) are directed towards a particular focal point. In addition, the configuration provides lens mouldings (62) and focus mouldings (85) which serve to direct and focus the light output from the LED's (1) to a particularly highly focused point. The lens mouldings (62) can be variable such as to enhance the focusing and alignment of the output light beams from the LED's (1) to further enhance the focusing to pinpoint accuracy.

Drawing 26

FIG. 26 shows a plan view of the apparatus of the invention where the PCB mounting board (2) is shown configured in a stepwise fashion with the lens moulding (62) positioned for interception of the light output of the LED's (1).

Drawing 27

FIG. 27 shows one specific adaptation of the invention where the angled and specifically mounted LED's (1) are positioned on a badge (14).

Drawing 28

FIG. 28 shows a side view where the PCB (2) provides a mounting facility for a range of LED's (1) where the LED's have selected variable focused light output (21) such that the combined configuration of a plurality of LED's provides a specific focal concentration and direction for the apparatus.

Drawing 29

FIG. 29 shows the light output of a PCB specifically configured for wrapping round a pole with the PCT in the flat or original position giving a frustoconical light output (21).

Drawing 30

FIG. 30 shows the effect of wrapping the PCB around a power pole (70) such that the distortion of the mounting of the LED's causes the light output (21) to be adjusted in the intended direction and focusing so as to provide a highly focused output for the apparatus of the invention when applied, as intended to a power pole.

### DETAILED DESCRIPTION OF THE INVENTION

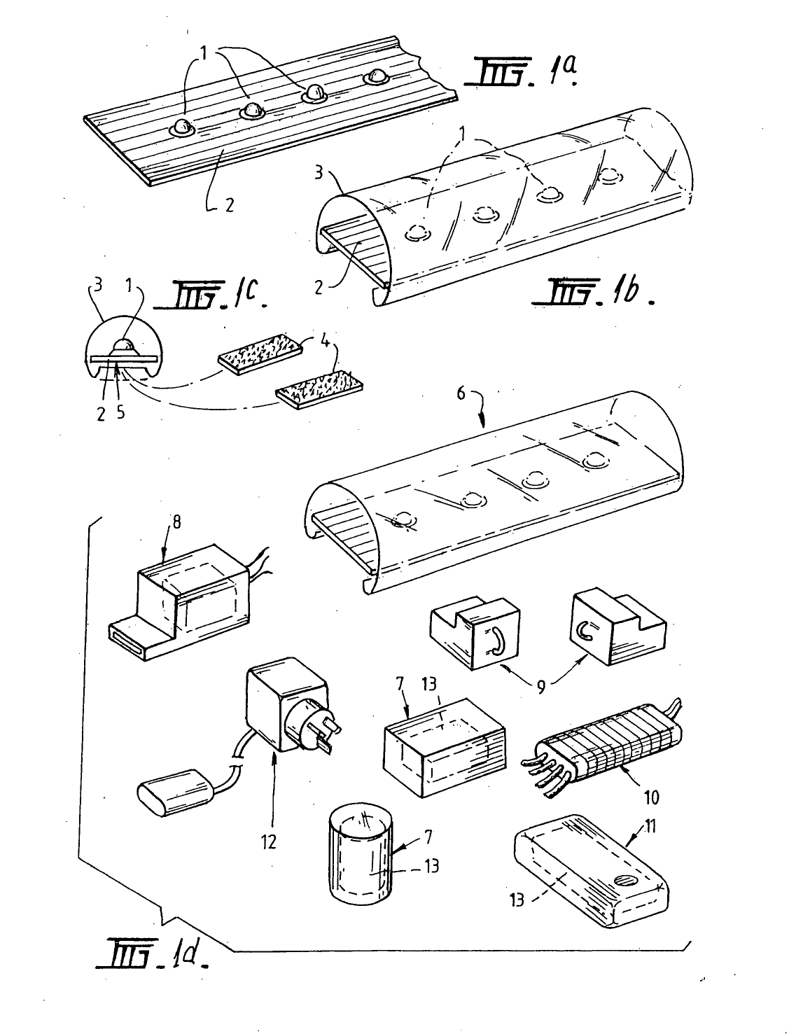

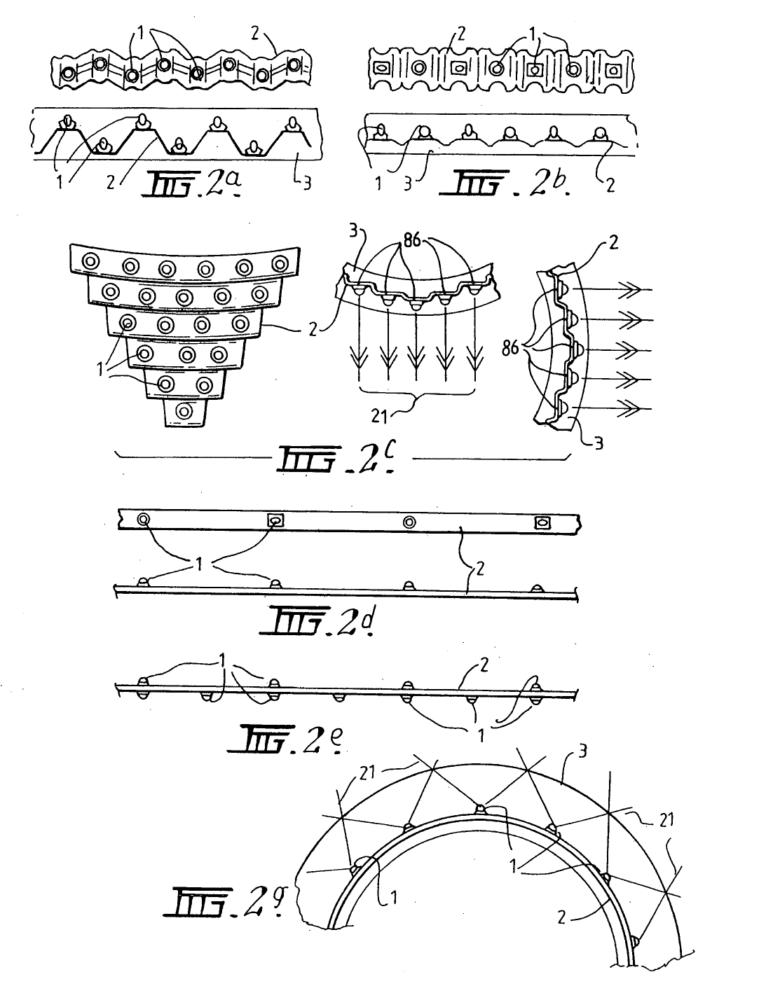

Referring firstly to FIGS. 1, 2 and 3, the invention may take the form of an elongate and flexible apparatus comprising a mounting means in the form of a flexible printed circuit board PCB 2 having positioned along the length thereof a plurality of light emitting diodes 1 in the form of a plurality of surface mounted devices SMD. A battery or other means may power the light emitting diodes LED's.

The visual recognition and identification apparatus of the invention provides a highly compact image or signal generating device relying on light emitting diodes as the signal generating means, where the light emitting diodes are mounted or supported directly onto a flexible and compliant printed circuit board. In this manner, the apparatus of the invention provides for the first time, a compact, compliant, flexible apparatus for emitting a signal including a visual signal, in a form that can be readily adapted to a wide range of applications, due to the compact lightweight and particularly flexible and compliant nature of the apparatus.

In particular, the compact nature of the apparatus allows the use of microchips or microprocessors which can be incorporated into the printed circuit boards for programmable controlling and operation of the LED's. In this manner, the complete apparatus can be presented in the form of lightweight, flexible, low energy demanding units that find wide application in a variety of situations, as will be described with reference to the further figures.

In the first preferred application of the apparatus of the invention, the apparatus takes the form of an elongate highly flexible, very compact strip with a plurality of service mounted, light emitting diodes as shown in FIG. 1a. In another embodiment shown in FIG. 1b, the printed circuit board, functioning as a mounting means, can be provided with a cover 3 in order to provide protective functions. The cover can also provide various colour indications, fluorescents, or other means to adjust the LED's output. The cover can also be filled with a clear or opaque filler, for example, silicone fillers provide a surprising enhancement of the visual features of the apparatus.

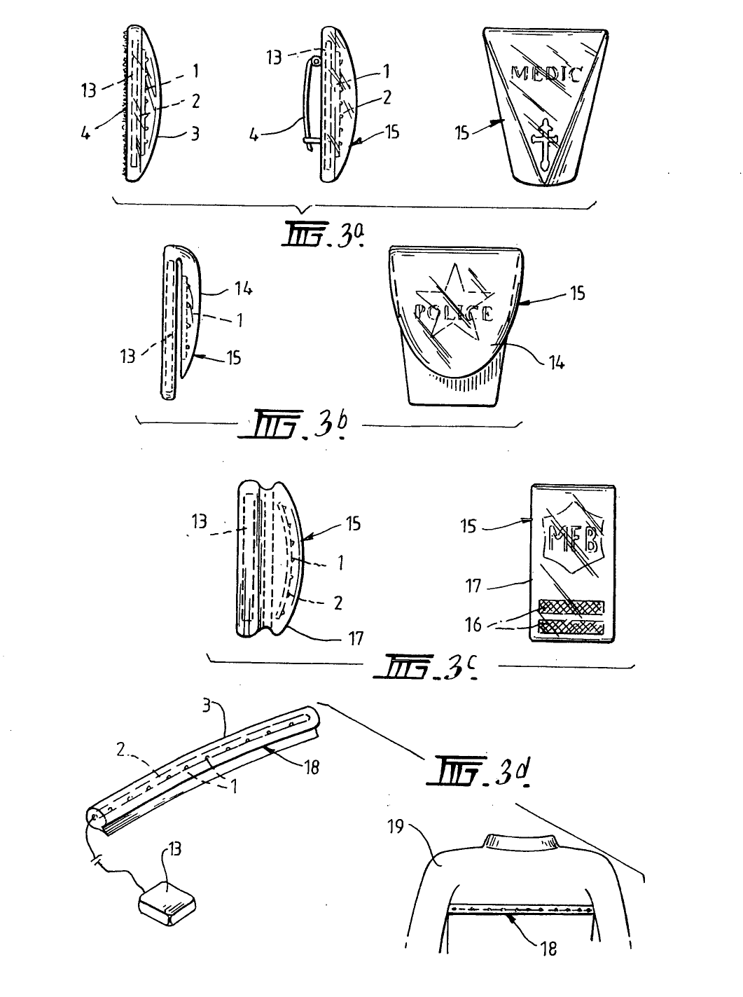

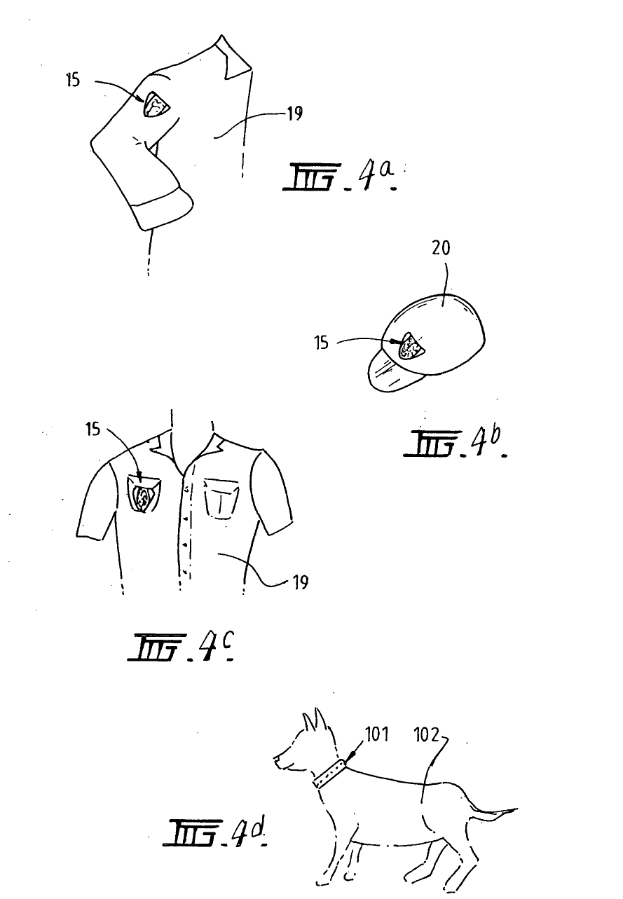

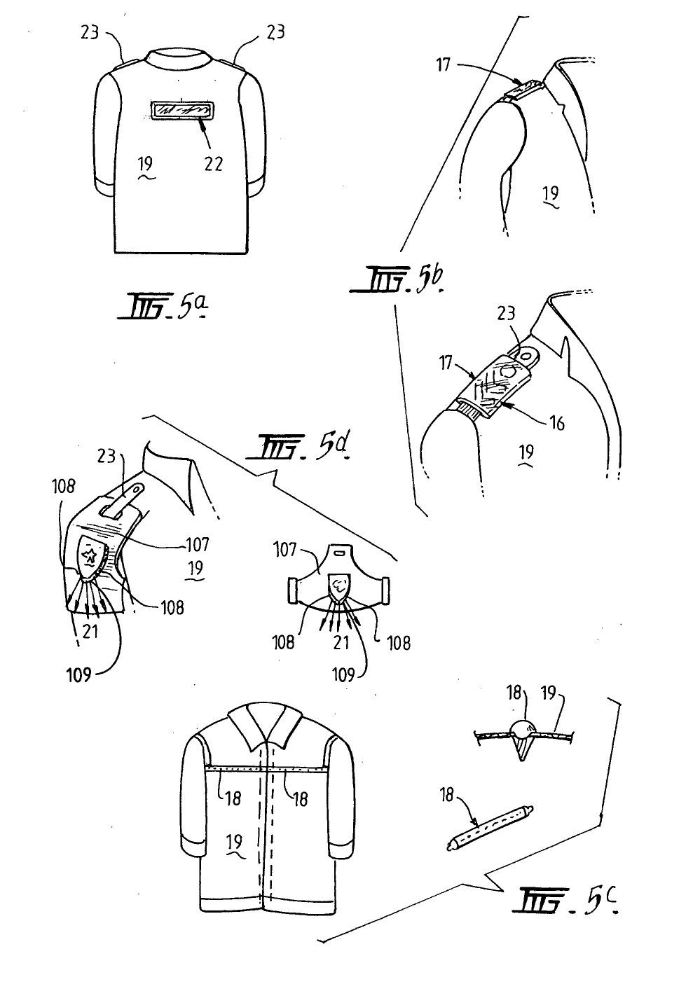

Referring now to FIGS. 2a to 2f, other physical formations of the apparatus of the invention is shown, where the printed circuit board can utilise its compliance and flexibility to be pressed or formed into particular shapes as required or preferred for select applications.

In this form, the apparatus of the invention provides a highly versatile illuminated device, which can be readily adapted and placed in a variety of physical situations to provide visual recognition and identification as required.

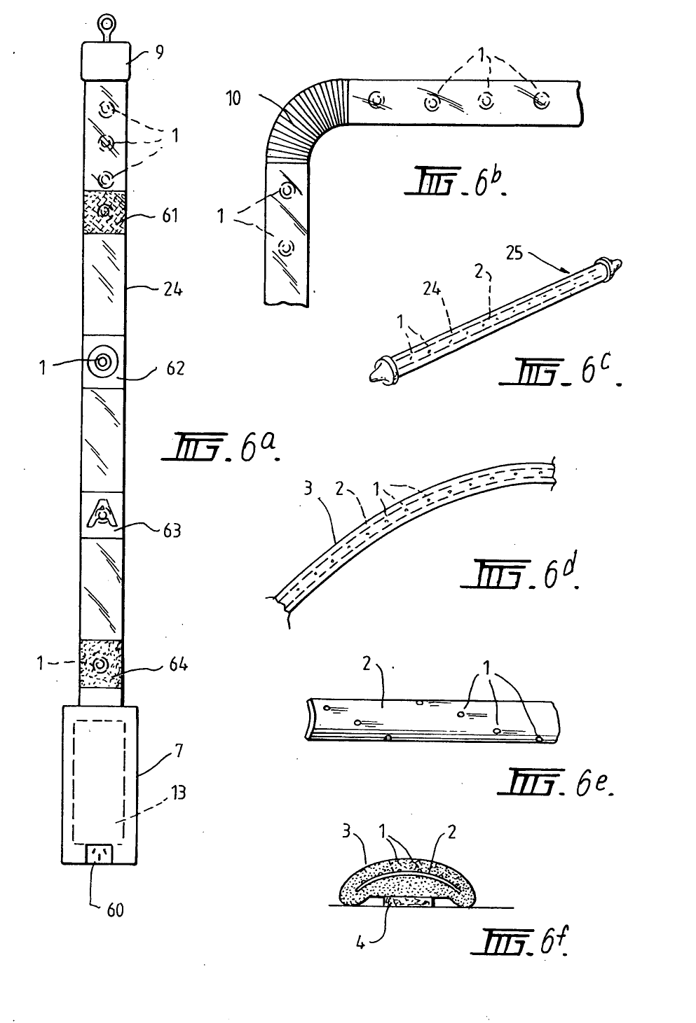

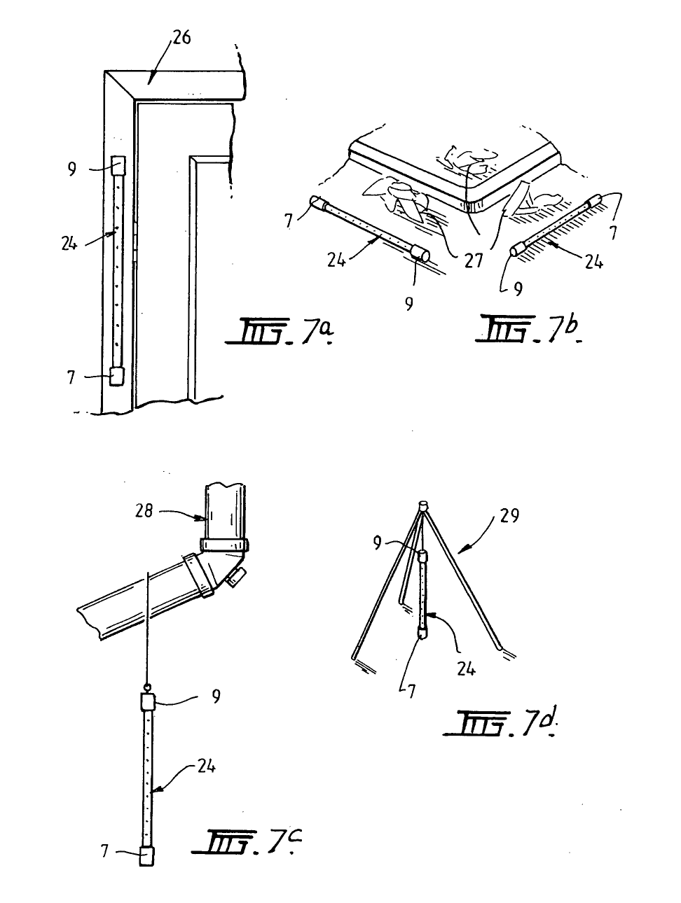

Referring now to FIGS. 3 to 5, the apparatus of the invention is shown as applied to a badge which is adapted for placement on a users clothing. The badge incorporates a plurality of LED's, which again can be powered from a modest battery pack. In this mode, the invention provides a ready means of identification personnel and a range of situations. E.g., fireman, ambulance drivers, police etc can readily identified notwithstanding low light situations and other hazardous environments.

Referring firstly to FIG. 3a, a totally self-contained device in the form of a badge for wearing by a user is shown, where the unit includes a number of LED's 1 mounted on a printed circuit board 2 and provided with a protective cover 3. The whole unit can be provided with a suitable fixing system 4, which can take various forms including velcro type fasteners, clips etc. FIG. 3b shows a clip on version of the same badge and FIG. 3c shows a slip-on version of the similar unit.

Referring now to FIG. 3d, the full versatility of the apparatus of the invention can be demonstrated when the invention takes the form of an elongate lightweight highly compliant and flexible strip, with a remote power pack 13. The apparatus in this form is readily stitched into or applied to a wearers clothing 19. As such, the wearer can now become highly visible by way of the light emitting diodes, which can be activated by the power pack, as a continuous emission of light. Alternatively, the light emitting diodes could be pulsed or programmed for activation according to particular circumstances. For example, an emergency worker may required sudden instruction, which could be remotely indicated via the apparatus of the invention.

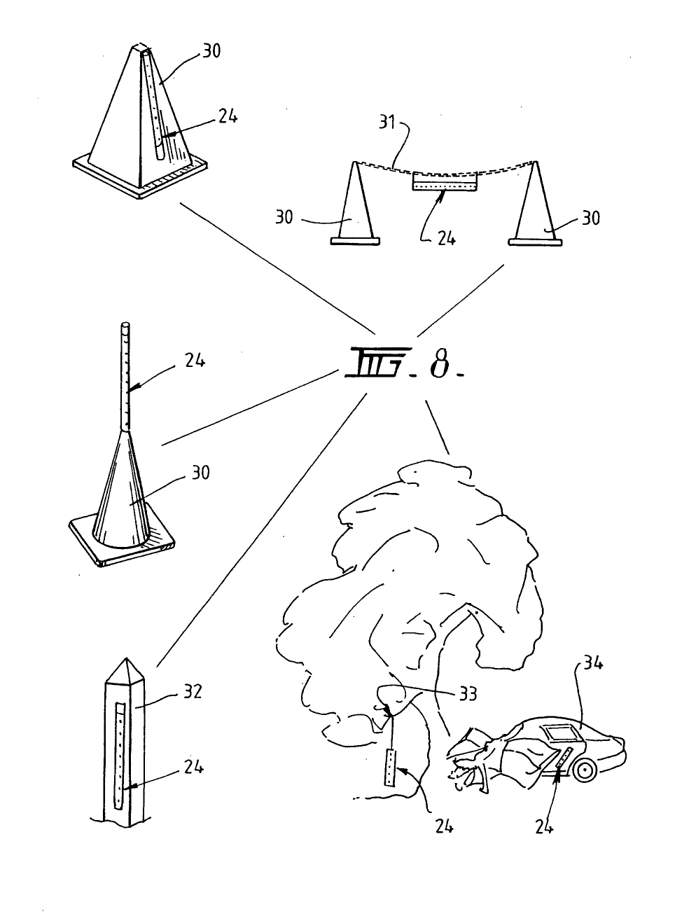

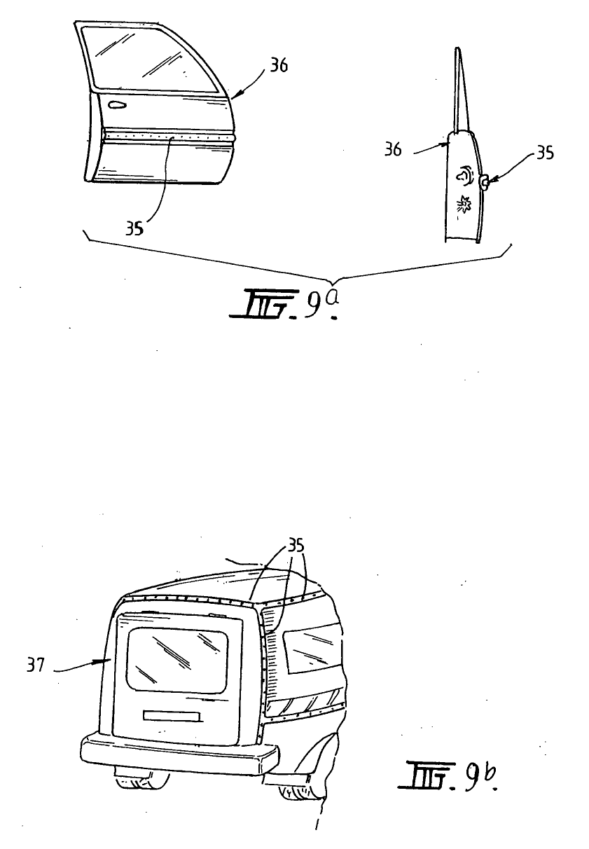

FIGS. 4a and 4b show alternative applications of the apparatus of the invention when applied in the form of a badge, where FIG. 4a shows the badge applied as a shoulder patch and FIG. 4b shows the badge applied as a cap patch.

FIG. 4c shows application to a pocket of a wearers clothing 21.

Another embodiment of the invention finds application with the apparatus being applied to a dog collar 101. Such an application, will allow an emergency services rescue dog 102 to become highly visible in situations where smoke or fumes may visually obstruct the presence of such a rescue animal.

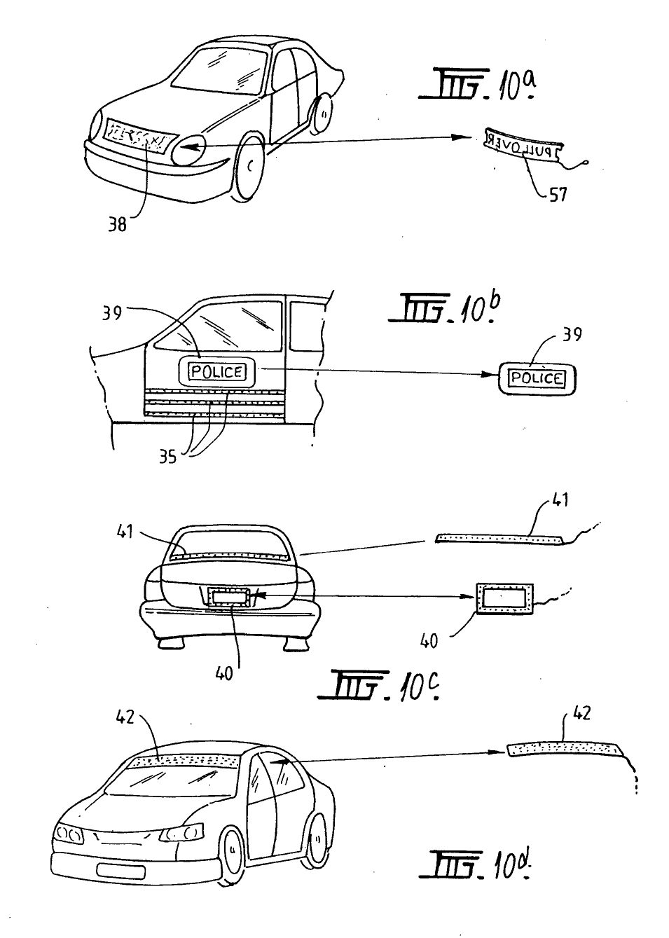

Referring now to FIGS. 5a-c, other applications of the invention are shown, where this form of the invention can be sewn on 22 to a piece of clothing. FIG. 5b shows the unit being applied to the shoulder flaps 23 of a piece of apparel 19, 21. FIG. 5c again demonstrates the high level of versatility of the invention where very lightweight compliant soft and flexible apparatus of the invention allows one of the units to be readily sewed or bonded into a piece of clothing, including safety harnesses etc.

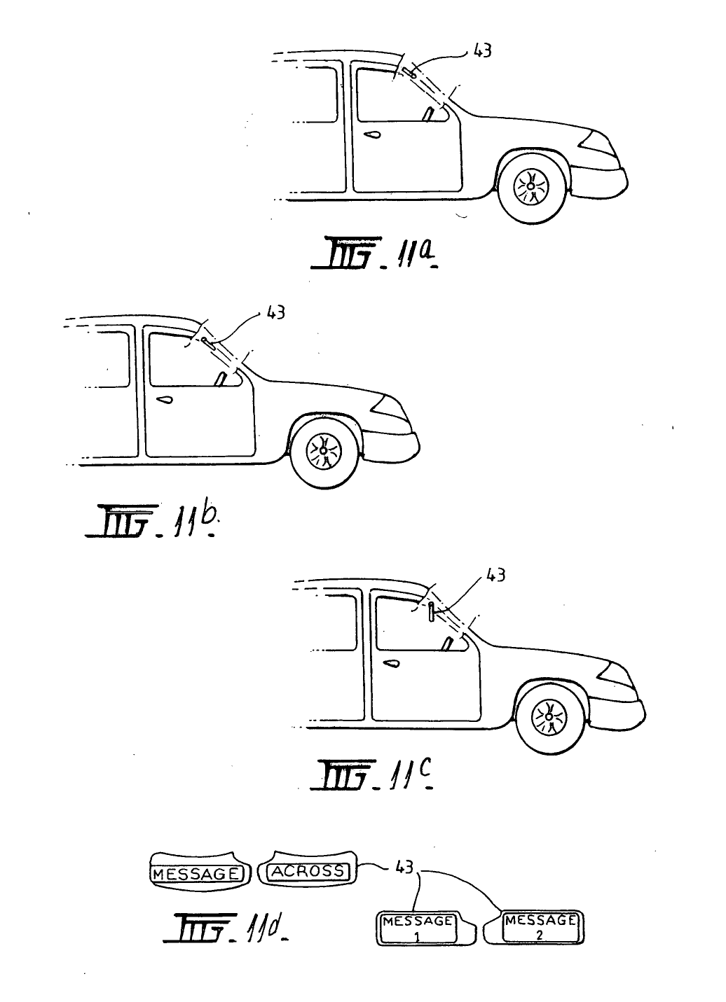

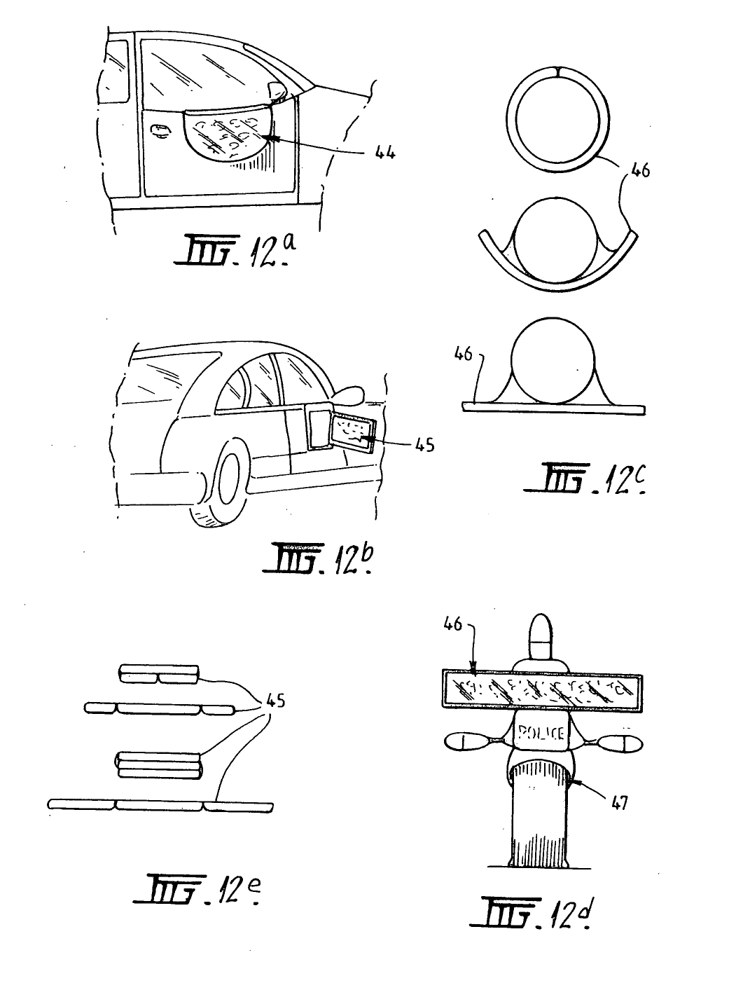

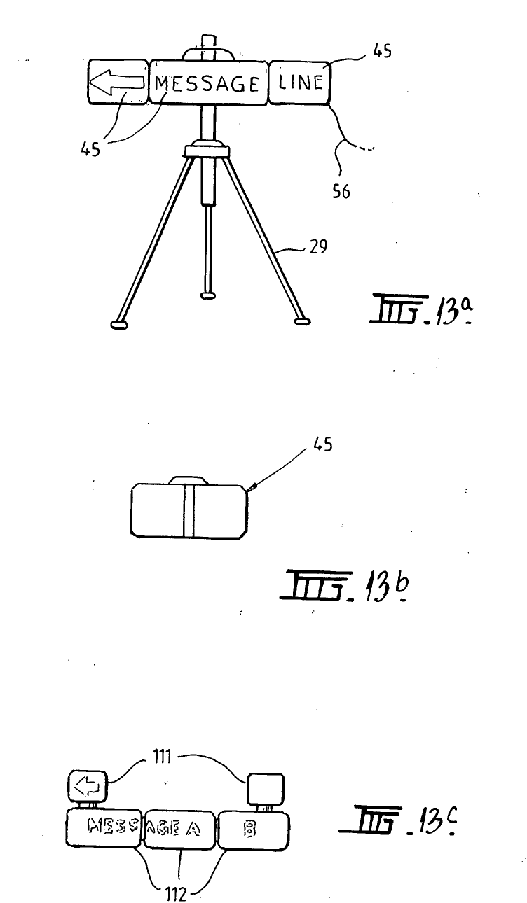

Referring now to FIGS. 6,7, and 8, various alternative embodiments of the invention are shown where the apparatus of the invention can be adapted for a wide range of applications. Referring to FIG. 6 the invention provides a variety of markings and the ability to be bent in several planes and joined for continuous runs. The high level of flexibility is again clearly demonstrated in this particular embodiment where the mounting means in the form of a flexible and compliant printed circuit board, allows the apparatus to be bent in a variety of planes and different directions, so as to provide continuous and un-interrupted visual displays over a wide range of physical situations. Referring firstly to FIG. 6a, the apparatus of the invention can be finished in a variety of ways, including reflective materials, lenses etc, which provide for directional control and a wide range of possible visual indications as appropriate. FIG. 6b shows two flexible elongate strips including the apparatus of the invention, where a flexible joiner 10 can be used to connect to strip formations of the invention. FIG. 6c shows the invention in the form of a sealed tube 24, 25. FIG. 6d shows the ability of the apparatus of the invention to be curved in a first plane. FIG. 6e shows the ability of the apparatus of the invention to be curved in a second plane. FIG. 6e shows the apparatus of the invention being curved in a first plane so as to provide a secure mounting and footprint for the application of a range of fixing means 4.

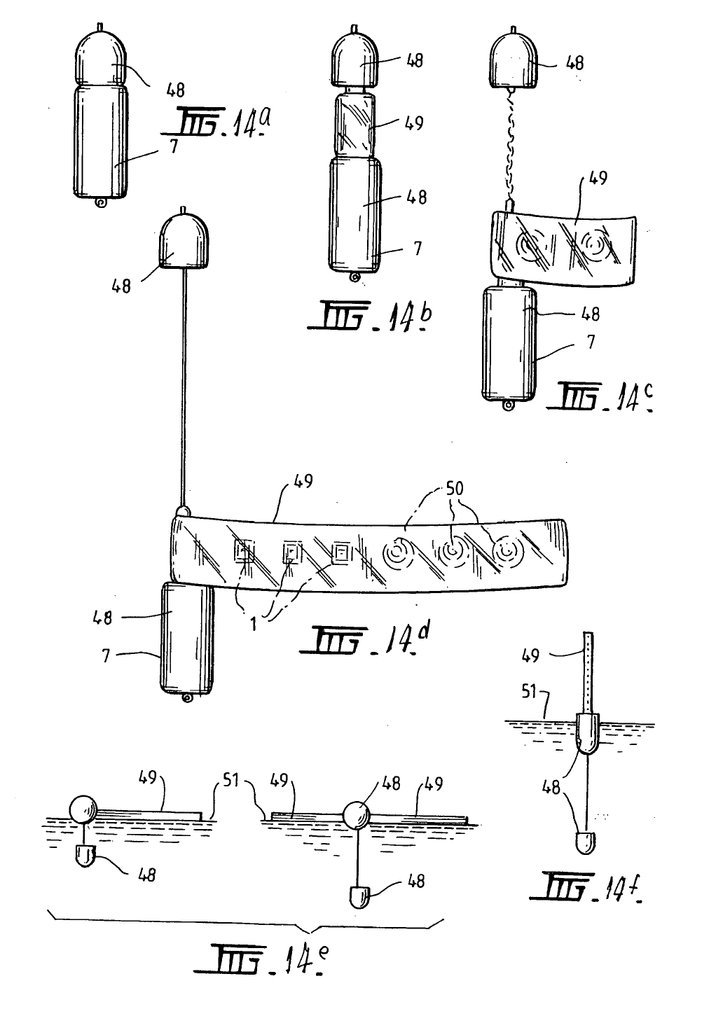

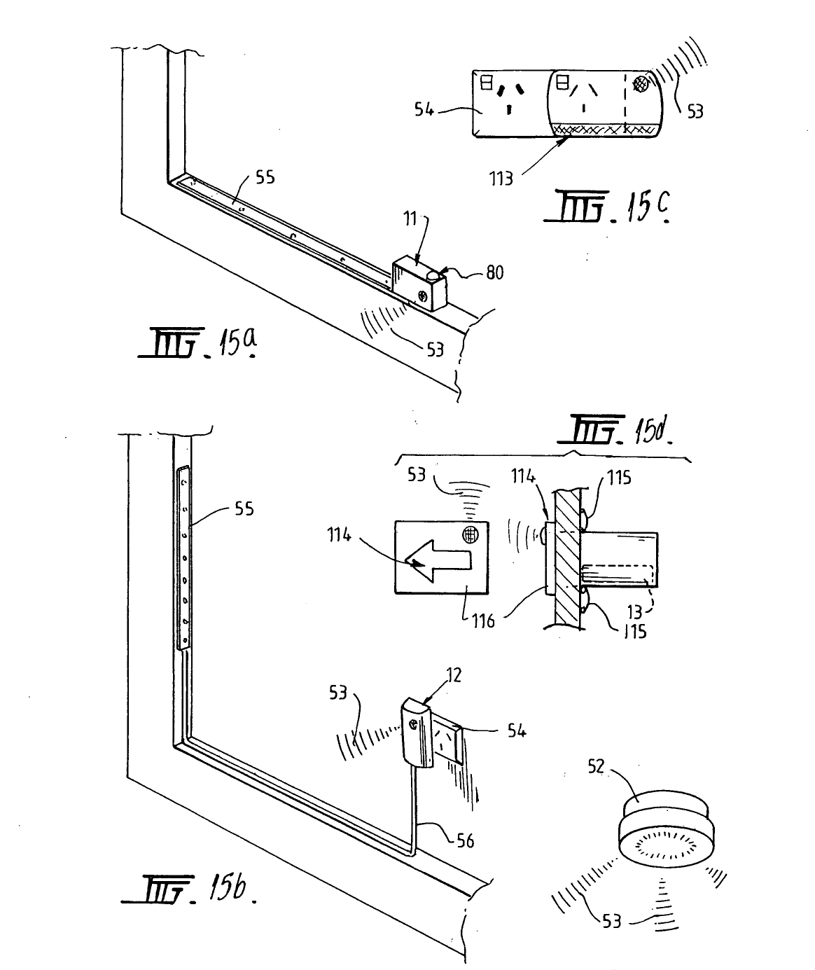

Referring now to FIG. 7, the apparatus of the invention can be applied to the manufacture of a wide range of safety and hazard reduction devices. The invention can provide a warning device for identifying a number of situations in an industrial environment where pipes, conduits and any number of hazardous situations may need to be readily and unambiguously identified by safety service personnel. This adaptation provides a particular application where the apparatus of the invention can be configured as an integral unit having a mounting means provided with a plurality of light emitting diodes and an integral battery power pack. Such devices are lightweight, robust and capable emitting sufficient light over a long period of time to provide the necessary identification of the hazardous site or critical staging area or specialised tool dump or other significant areas requiring ready identification by safety workers. Referring firstly to FIG. 7a, the invention can be applied as a strip formation for application around the architraves of a door or window. In this manner, particular parts of a building can be readily identified for quick exit, or alternatively, can identify a hazard. FIG. 7b shows the situation where an identified hazard 27 can be delineated and cordoned off by the placement of an emergency warning device 24 including the apparatus of the invention. FIG. 7c shows similar device being attached to a water pipe 28 identified as a hazard. FIG. 7d shows being used within a tripod, again for ready identification of a hazardous situation. Referring now to FIG. 8, the invention provides apparatus well adapted for use in an urgency situation or accident site. Referring to the various examples shown in FIG. 8, the apparatus of the invention finds application for the manufacture of a wide range of hazard reduction devices which can be applied to hazard or other warning situations including safety cones 30, which can incorporate the apparatus of the invention. Safety chains strung between cones or other situations 31. Roadside pickets or poles 32, can be provided with such an apparatus, and the apparatus can be applied to motor vehicles or other accident situations 34, by application to the vehicle itself or a tree branch 33.

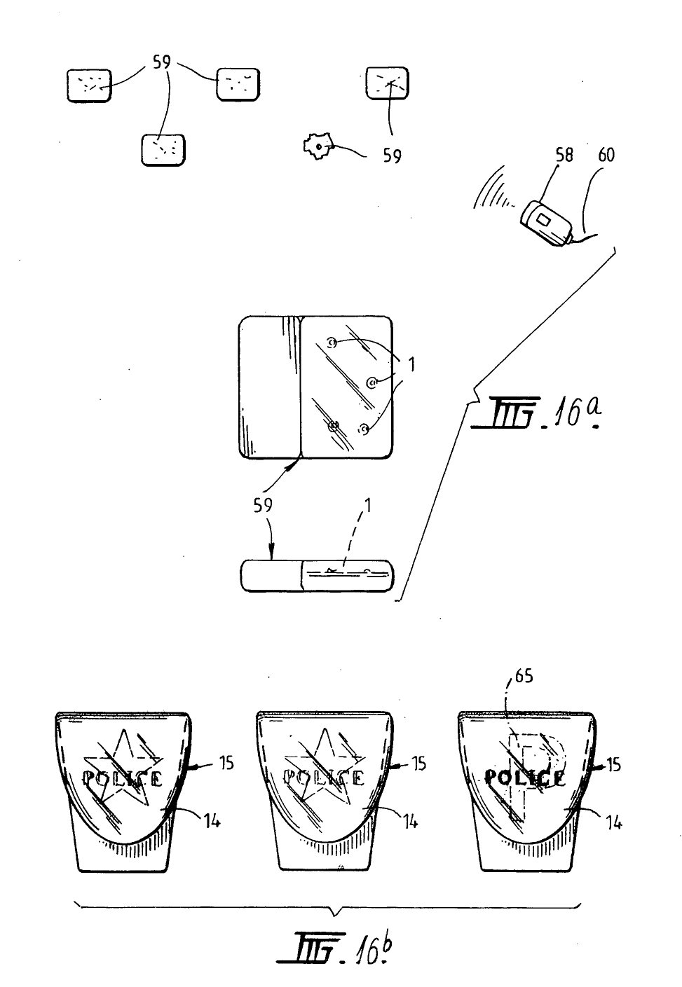

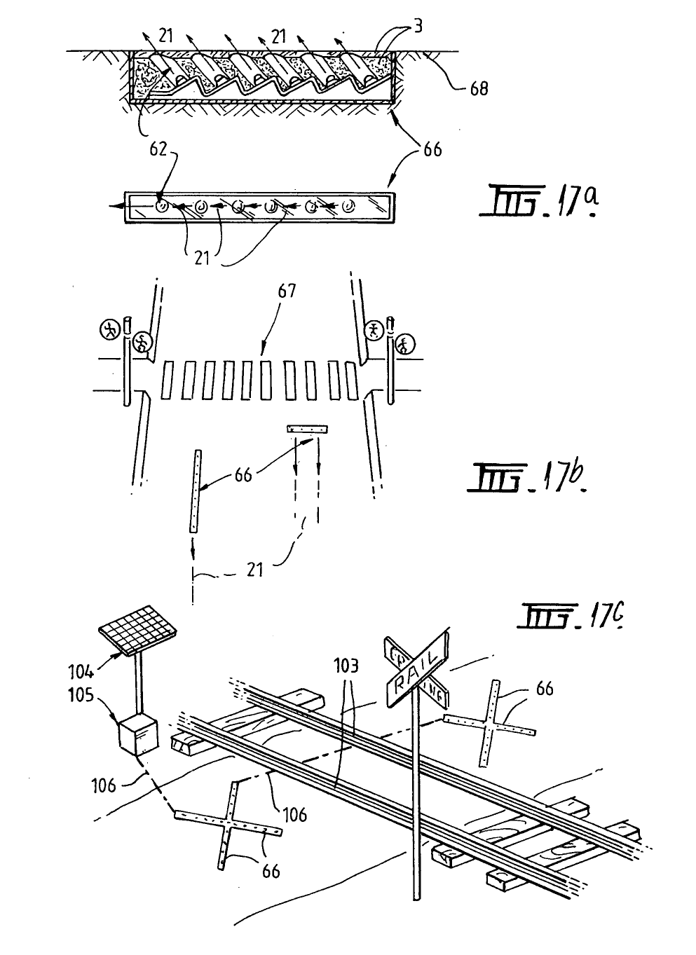

Referring now to drawing 9 and 10. Drawing 9 shows, the apparatus of the invention incorporated within an existing automotive rubbing strip or profiled to outline and identify particular vehicles. Drawing 10 shows the apparatus of the invention integrated within various automotive accessories. FIG. 9a shows the strip formation or application of the apparatus of the invention as applied to a car door 36. FIG. 9b shows an other application of such device to an emergency vehicle 37 where the strip formation of the device can be applied to parts of the vehicle for ready identification. FIG. 10a shows another variation of the strip application of the apparatus of the invention, for fitting behind a contoured window deflector of a cars bonnet. FIG. 10b, shows another formation of the device applied to the side door of a vehicle, or as part of their protective rubbing strip 35. FIG. 10c shows a similar device incorporated as part of the infill or around the number plate 41 and FIG. 10d shows a similar device applied inside to the profile of a curved windscreen 42.

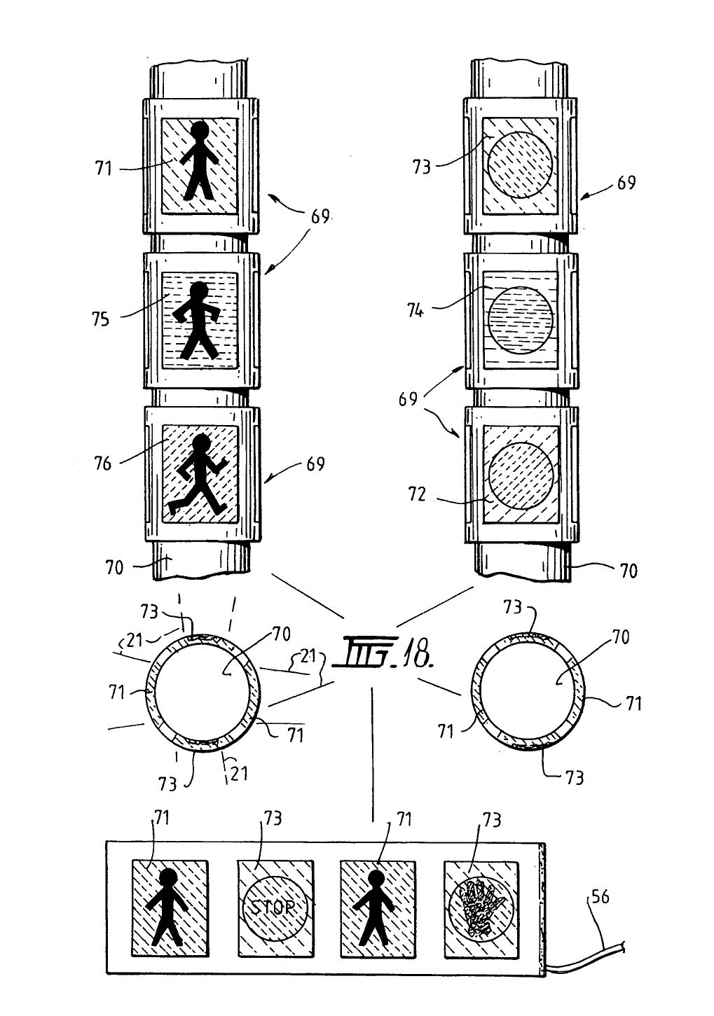

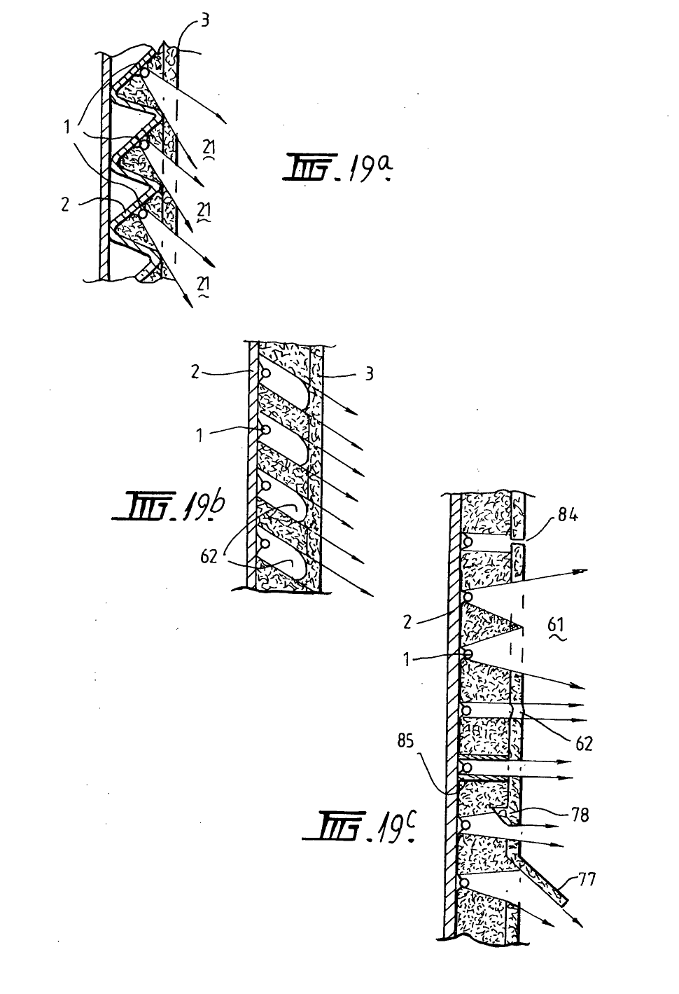

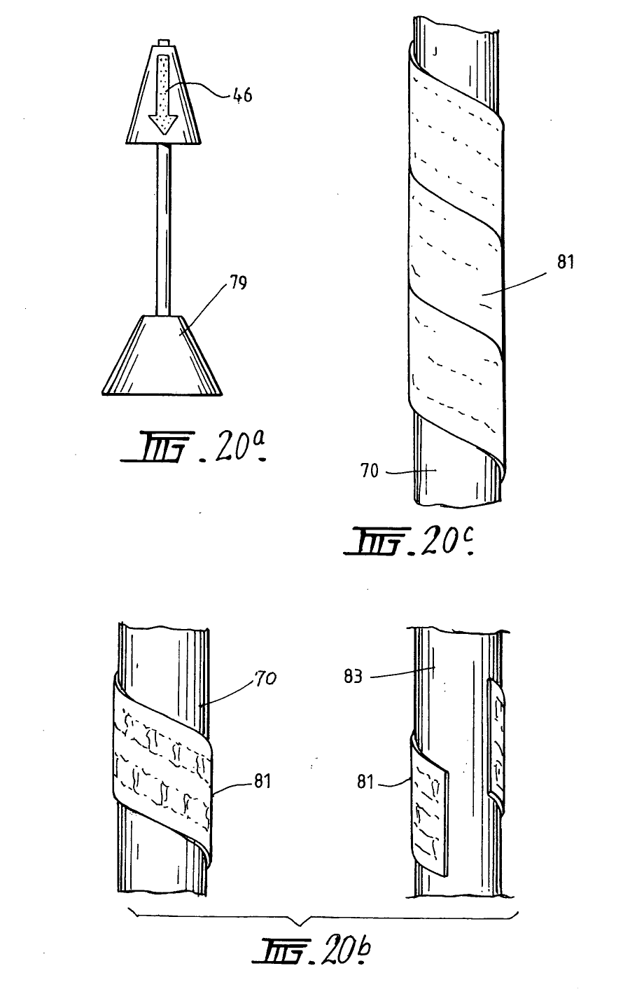

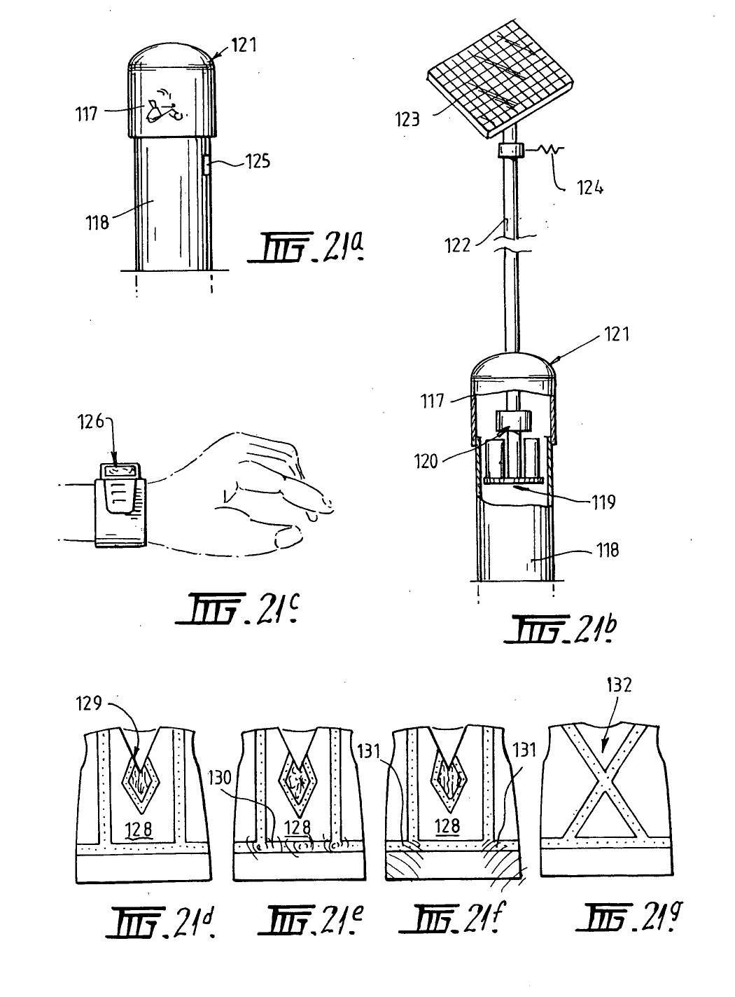

Referring now to drawings 11,12 and 13. The light emitting diodes are arranged in a plurality of a seven-bit matrix allowing representation of all standard alphabetical and numerical symbols. The flexibility of the invention allows messages to be reproduced as programmed on a range of non-flat surfaces or allows transportation of the message board in simple packaging and assembly at the needed site. In drawing 11, the message board is attached and contoured to follow the shape of the sun visors behind a windscreen. FIG. 11a shows an application of a message board behind the windscreen 43 or sun visor, such that it can be pulled down and readily accessed for reading of the message board. Referring now to FIG. 12a, a message board could be applied permanently to the door of a vehicle or could be configured as a fold out flexible message board 45. Referring now to FIG. 12c, the message board can be manufactured as a flexible compliant device and can be readily applied or configured to a curved position 46. Referring now to FIG. 13, the message board 45 can be applied to a tripod 29 and can incorporate a various folding component 45.

Drawing 14 details an embodiment of the invention for use in marine rescue.

The marine rescue application of the invention, shows a water rescue tube 48, including a very particular application of the apparatus of the invention in the form of a thin special memorised shaped visual indicator 49.

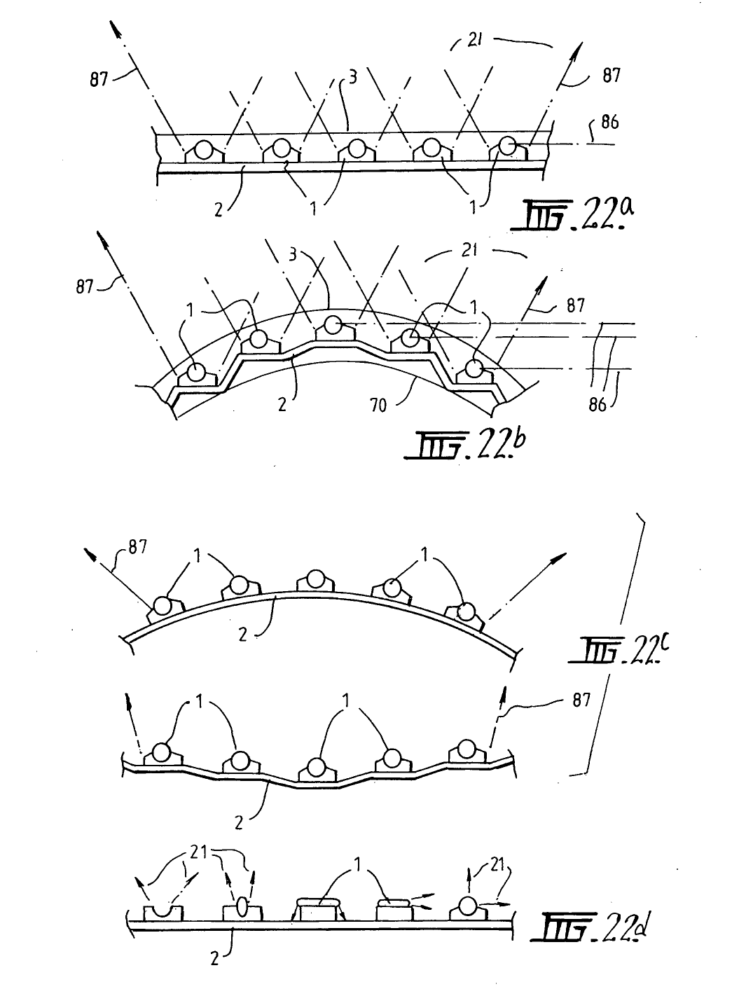

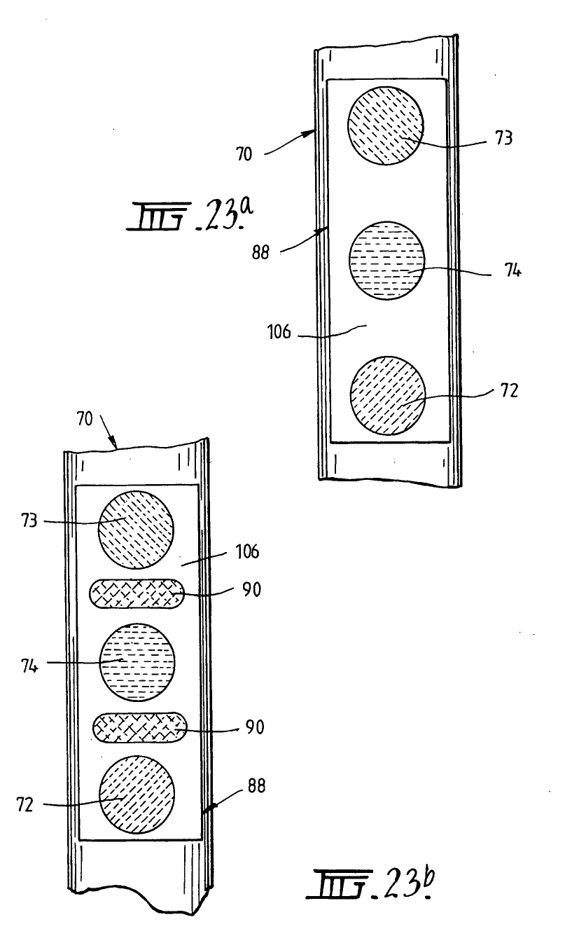

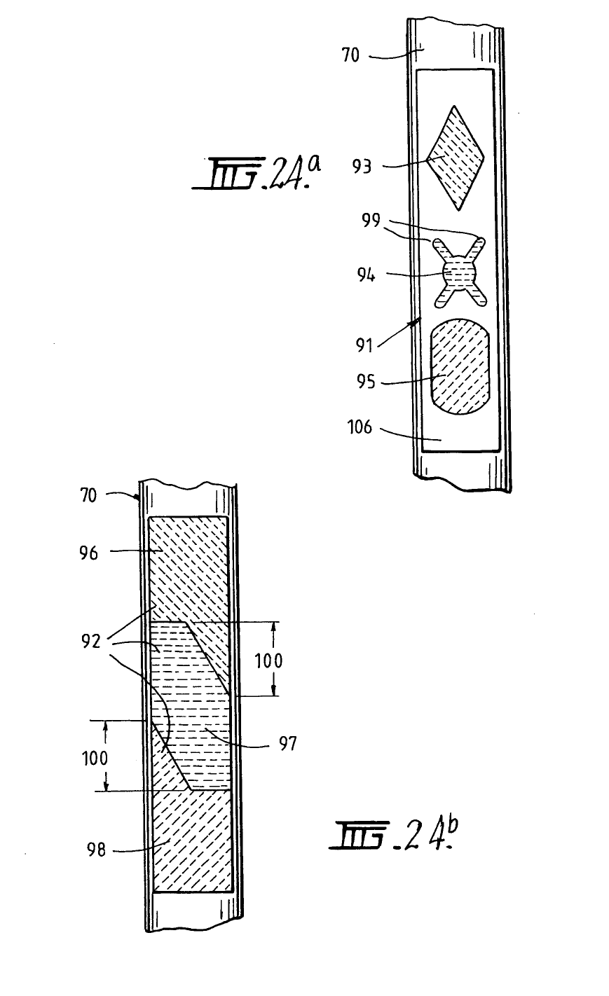

Drawing 15 the apparatus of the invention provides a highly efficient, low maintenance yet simple light pathway triggered by the audio output of a simple domestic smoke alarm and or combined with circuit dropout detection. The smoke detector application of the invention can take the form of a very fine clear covered device incorporating the apparatus of the invention, where a smoke detector 52 will, in the normal situation, provide an audio signal representation 53, which serves to activate the device of the invention, which takes the form of an elongate strip, placed along the skirting board or appropriate parts of a building to indicate an exit route. This application of the invention can rely on integral power source in the form of an enclosed battery, or as detailed in FIG. 15b, can rely on a remote power pack which is connected by wiring 56 to the device of the invention 55.

Drawing 16 provides a particular application for military use as a multiple unit, remote switched stealth walkway. A further embodiment of the badge allows alternative use of infrared LED's within the badge configuration for security identification by infrared detection.

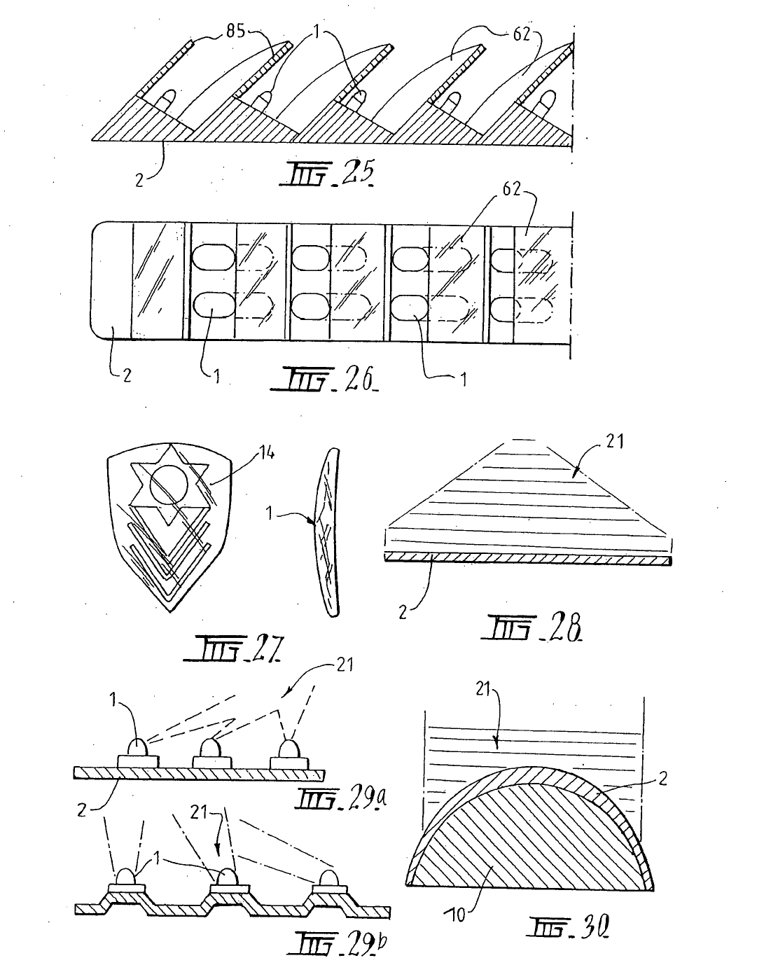

Referring to drawing 17 the ability of the invention being able to fine tune the light emission angles and yet miniaturise a warning signal provides a particular application for roadways adjacent to pedestrian, rail crossings or other designated dangerous road hazards. FIG. 17a shows the apparatus of the invention applied to road surface 68, where the apparatus includes a number of lens mouldings 62. This in-road application of the apparatus of the invention, can also incorporate micro-versions of the apparatus, which require minimal interruption to a road surface and can in fact, be accommodated within a saw width cut into a road surface. The LED's are small enough in size to almost be covered within the texture of a normal road surface and provide a highly efficient device for providing visual signals on a road surface. FIG. 17b shows the application to a pedestrian crossing 67. FIG. 17c, shows application to railway crossing, where the device 66 can be applied within a road surface, leading up to a railway crossing and powered by solar panels 104 and storage batteries 105.

Referring to drawings 18 through to 20 and 22 through to 24 shows various alternative embodiments of the invention where the ability to manipulate the cut off angles from the LED's is critical. Referring firstly to FIG. 18, the apparatus of the invention can be applied to a device for use as a pedestrian lantern, as applied to a power pole 70. The various visual representations for the pedestrian crossing, indicating go, stop and intermediate, can be seen in items 71 to 76. This figure also shows a plan view where the compliant and flexible nature of the apparatus of the invention, particularly lens itself to wrapping around the circular shape of a pole.

Referring now to FIGS. 19a-c, the directional light output of the apparatus of the invention can be uniquely and precisely controlled while the application of lens mouldings 62, focusing shafts 85, pin holes 84, internal levers 78 and external levers 77. All these various features provide the ability to enhance and direct the printed circuit board, so as to provide a defined angle of illumination for the LED suite of the particular applications in question.

Referring now to FIGS. 22a, b and c. 22a shows a flat printed circuit board with LED's showing the cut off angles generated by light 87. FIG. 22b shows an altered printed circuit board, which is utilised a flexible and compliant nature of the mounting means and has been bent around a curved surface, such that various faces can be configured to remain parallel to each other, by virtue of the highly compliant nature of the printed circuit board. Referring now to FIGS. 23 and 24, the apparatus of the invention finds application in a traffic signal 88, where the various lights 72, 73, 74 and 90, form the illuminated parts of the signal, utilising the apparatus of the invention.

Referring to Drawing 20 shows the apparatus of the invention incorporated within an emergency workers safety vest providing a visual image to an observer. Also incorporated within the vest is a personal safety warning controlled by a remotely triggered signal. The signal may activate a tactile, audio, visual or combination warning within the vest or emergency clothing. The generation of the signal may be by the automatic detection of a danger or remotely by the site controller.

The invention can be seen to provide a wide range of highly innovative products based on the apparatus of the invention, having a wide range of safety and communication features. The advantages of the invention are by no means limited to the previously described embodiment, but do contain at least following major advantages.
Internally illuminated badges and signs capable of being bent and attached by various means so as to profile or skin a curved or non-flat surface. The PCB is physically modified to provide a distinct angle of mounting for single or groups of LED's to allow a very defined viewing angle when mounted.
   Eg The required cut off viewing angles for traffic signal lights are calculated with the full allowance for the curvature around a pole.
   Where a flat mounting surface is present, the internal PCB may be manufactured to provide a sloped pad for the mounting of a SMD led at a particular angle to allow total direction light control.
   A flat mounting pad for a Led may be used where a message is required to be visible up to 360 degrees around a pole. The PCB is pre pressed in manufacture so that when the PCB is fully curved around the pole the LED mounting pads are flat and no solder stress is evident. Similar effect to a fluted lampshade but with flat inner segments rather than sharp angles between the flutes 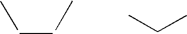
   Specialised shapes such as a cone can have the PCB manufactured to allow special flat LED mountings for specified viewing angles. Note LED's can have their light projected at very defined angles directly in front or totally to one side. Some can have some light back spill and the PCB can be manufactured to reflect most of this light back in the same direction as the major light from the front (or side)
   The light producing LED's within the badge, sign or other designs are encased within a soft bendable or pliable diffusing medium to further allow shape profiling where required. The outer cover being flexible and moulded with possible further light control devices such as lens. The bendable base material may be of a compressible material to compensate for minor variations in the mounting surfaces.
   The PCB may be manufactured to be mounted in several planes whilst still allowing the LED solder pads are to be flat thus avoiding solder stress
   The ability to make small very flexible and shallow lights strips allows the use of them on gloves as illuminated traffic control gauntlets.
   A variety of different angled LED's may be combined with the PCB to achieve the specified angles.
Jacket can be fitted with
   The front LED's apart from their normal use as a visual indication of the wearer are mounted and configured to function as a short focal (arms length) flat torch
   Internal circuitry to produce a visual, audio or tactile warning signal (or any combination) within and/or on a safety jacket to warn the wearer of a possible approaching danger. The danger may be hidden from the wearer but detectable and signalled by a remote observer with a wireless transmitting control or by detection devices that generate a warning signal automatically. This provides critical extra escape time for a safety worker wearing the vest or jacket.
   The remote external detection devices may be of many types. They may detect physical movement of the actual detection unit, or the presence of dangerous gas, light changes, electrical circuit triggers, pulse, sound, radar or infrared monitoring devices, changes in air pressure or temperature or fluid levels. All are modified to trigger the safety vest when a dangerous circumstance occurs

Note any safety apparel could be fitted with these features. The hands free torch configuration at the front of the garment, harness or safety clothing and the internal warning devices.

The automatic generation of a signal could also be used for security for the remote detection device from theft or vandalising.

Led based illumination may be of

LED's
Normal through hole tailed type
Surfaced mounted
Front, rear or side light projection. Angles include less than 10 degrees to over 270 degrees. Performance varies depending where and how the light output is measured
By the use on internal components including doping with rare earths almost all colours are available.
They maybe manufactured in singles or supplied in clusters of numerous LED's together. Increase performance
The maybe a RGB type which combines several separate segments to produce most colours including ‘white’. The colour changes are controlled by a microprocessor within the circuit The same effect may be obtained by carefully mixing of individually coloured LED's
Several different colours maybe mounted close together to allow a colour change by microprocessor control switching. One colour turns on whilst another is extinguished

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. A visual recognition and identification apparatus comprising a mounting means adapted for placement on an object wherein said mounting means incorporates one or a plurality of light emitting diodes adapted to provide a visual signal characterised in that said LED's are mounted in, on, or connected to a printed circuit board, wherein said printed circuit board is surface modified to provide a distinct angle of mounting for one or a plurality of LED's to provide a highly defined focused viewing angle for said apparatus, wherein said mounting angle results in the focusing of said LED's at a defined focal point.

2. An apparatus according to claim 1, wherein the light output from said LED's is further focused by lens means positioned to intercept said light output.

3. An apparatus according to claim 2, wherein said printed circuit board is manufactured from a compliant material, but substantially retains said LED mounting angle during compliant movement.

4. An apparatus according to claim 3, wherein said printed circuit board forms said mounting means so as to provide a flexible and compliant apparatus.

5. An apparatus according to claim 1, wherein said printed circuit board is controlled by a microprocessor.

6. An apparatus according to claim 1, wherein said printed circuit board incorporates a microprocessor microchip for controlling said LED's.

7. An apparatus according to claim 5, wherein said microprocessor is programmable.

8. An apparatus according to claim 1, wherein said mounting means is a sloped pad.

9. An apparatus according to claim 1, wherein said mounting means is an elongate strip.

10. An apparatus according to claim 1, wherein said mounting means is a sealed tube containing said LED's.

11. An apparatus according to claim 1, wherein said mounting means is a shaped moulding.

12. An apparatus according to claim 1, wherein said mounting means including a power supply for said LED's.

13. An apparatus according to claim 12, wherein said power supply is a rechargeable battery.

14. An apparatus according to claim 1, wherein said LED's emit ultraviolet wavelength and/or infrared light in addition to said visual signal.

15. An apparatus according to claim 1, wherein said mounting means includes a protective cover.

16. An apparatus according to claim 15, wherein said protective cover includes any one or a combination of integrated lenses, covers or other means to control the directional output of said apparatus.

17. An apparatus according to claim 1, wherein said LED's are switched.

18. An apparatus according to claim 17, wherein said switch is an automatic detector activated by a select signal.

19. An apparatus according to claim 18, wherein said select signal is smoke.

20. An apparatus according to claim 18, wherein said select signal is sound.

21. An apparatus according to claim 18, wherein said select signal is temperature.

22. An apparatus according to claim 1, wherein said LED's are programmed to emit a pulsed light signal.

23. An apparatus according to claim 12, wherein said LED, printed circuit board and power supply are formed as a sealed illuminated decal.

24. A badge adapted for placement on a wearer's clothing including an apparatus according to claim 1.

25. A badge according to claim 24, wherein the mounting means includes a clip for attachment to a wearer's clothing.

26. A badge according to claim 24, wherein the mounting means includes a slip-on fitting for attachment to a wearer's clothing.

27. A clothing accessory including an apparatus according to claim 1, wherein the mounting means is adapted for sewing into an item of clothing and incorporation therewith.

28. An accessory according to claim 27 wherein said power supply is a rechargeable battery, adapted for storage in a pocket of said clothing.

29. A clothing patch including an apparatus according to claim 1, wherein said patch is adapted for sewing onto the item of clothing.

30. A clothing patch according to claim 29 adapted for fitting to a shirt sleeve, a cap or any other item of clothing.

31. An animal collar including an apparatus according to claim 1.

32. An emergency warning device including an apparatus according to claim 1.

33. A device according to claim 32 including any one or a combination of fixing means selected from clips, self adhesive tape, magnetic stripping, handles, suckers etc.

34. A fire alarm system including an apparatus according to claim 1, wherein said apparatus is adapted for positioning on skirting boards, door architraves and windows and wherein said alarm is and adapted for sound activation by a smoke alarm or other wireless means.

35. A fire alarm system according to claim 34 wherein said activation is by an RF generator via a dedicated signal to said apparatus.

36. A message board including an apparatus according to claim 1, wherein said apparatus is adapted to visually display said message.

37. A message board according to claim 36, wherein said apparatus is programmable to display a message of choice and is able to amend said message as required.

38. A road message or warning device including an apparatus according to claim 1, wherein said apparatus is installed into a road surface.

39. A device according to claim 38, incorporated as part of a pedestrian crossing or railway warning crossing.

40. A road traffic signal including an apparatus according to claim 1, wherein the visual signal is provided by said apparatus.

41. A traffic signal according to claim 40 wherein said apparatus is directionally sensitive so as to provide lane definition.

42. A traffic signal according to claim 40 wherein said apparatus is activated by an indicative loop in said road.

43. A point of sale message board including an apparatus as claimed in claim 1.
